(19) United States
(12) Patent Application Publication
(10) Pub. No.: US 2026/0110945 A1
(43) Pub. Date: Apr. 23, 2026

(54) Base of Periscopic Camera Module, Manufacturing Method Thereof, and Periscopic Camera Module

(71) Applicant: NINGBO SUNNY OPOTECH CO. , LTD., Ningbo, Zhejiang (CN)

(72) Inventors: Osada HIROSHI, Ningbo, Zhejiang (CN); Yanxia KONG, Ningbo, Zhejiang (CN); Kailun ZHOU, Ningbo, Zhejiang, (CN); Liangjie WENREN, Ningbo, Zhejiang, (CN); Hua BAI, Ningbo, Zhejiang (CN); Takehiko TANAKA, Ningbo, Zhejiang, (CN); Hailiang WANG, Ningbo, Zhejiang (CN); Hongde TU, Ningbo, Zhejiang, (CN)

(21) Appl. No.: 19/133,563

(22) PCT Filed: Nov. 6, 2024
(86) PCT No.: PCT/CN2024/130138

§ 371 Date: May 28, 2025

(30) Foreign Application Priority Data
Jun. 4, 2024 (CN) 202410715215.5
Nov. 1, 2024 (CN) 202411549212.5

(51) Int. Cl. G03B 5/00; G02B 23/08; G02B 27/64; G03B 13/34

(52) U.S. Cl. CPC G03B 5/00; G02B 23/08; G02B 27/646; G03B 13/34; G03B 2205/0007; G03B 2205/0069

(57) ABSTRACT

A base of a periscopic camera module, includes: a housing including a bottom wall and a side wall located on a peripheral side of the bottom wall; a plurality of conductive members, each of the plurality of conductive members including a connecting branch embedded in the bottom wall and a mounting branch embedded in the side wall, the connecting branch and the mounting branch being connected, where the mounting branch includes a first portion, a second portion, and a third portion distributed separately from each other on the side wall; an anti-shake coil, conductively connected to the first portion, where the anti-shake coil is parallel to a first optical axis and perpendicular to a second optical axis; and a focus coil, conductively connected to one of the second portion and the third portion, to be disposed on different sides relative to the anti-shake coil.

### CROSS-REFERENCE TO RELATED APPLICATIONS

This application is a U.S. National Stage under 35 U.S.C. 371 of the International Application Number PCT/CN2024/130138, filed on Nov. 6, 2024, which claims priority to Chinese Patent Application No. CN202410715215.5, filed on Jun. 4, 2024, and Chinese Patent Application No. CN 202411549212.5, filed on Nov. 1, 2024, the contents of which are incorporated herein by reference in their entirety.

### BACKGROUND OF THE PRESENT INVENTION

### Field of Invention

The present disclosure relates to the field of optical imaging, more particularly to a base of a periscopic camera module, a manufacturing method thereof, and a periscopic camera module.

### Description of Related Arts

Camera module is an indispensable part of mobile electronic device. With the further development of camera module technology, users'demand for camera module has become more and more refined. The development of camera products not only needs to meet the high-performance requirements such as background blur, night shooting, dual-camera zoom, etc., but also needs to meet the requirements of miniaturization, lightness, and compactness. In particular, the periscopic camera module can have a longer focal length on the basis of the folded optical path through the optical path turning portion and the lens portion, and can meet the requirements of high zoom and lightness at the same time, thus having a broad market prospect.

The periscopic camera module usually has a base for accommodating an optical path turning portion, a lens portion, and a circuit board, and then the electronic assembly fixed on the circuit board can control and drive the optical path turning portion and the lens portion to move in the base to realize functions such as focusing. However, the mounting position and mounting method of the circuit board on the base need to consider many factors such as the position of the optical path turning portion and the lens portion, so the design is complicated, and the circuit board will occupy the space inside the base, resulting in the large size of the base, which makes the miniaturization of the periscopic camera module more difficult, and the exposed circuit board is difficult to be protected, is easily to be damaged in the case of collision, drop, etc., which affects the reliability and service life of the periscopic camera module.

In addition, the motor circuit and the circuit board in the camera module are usually connected by coils on the FPC, which are connected by the FPC and the circuit board. When setting the FPC, it is necessary to consider the mounting position, size, and fixing method of the circuit board. The circuit design is complex, the module assembly steps are many, and the mounting accuracy is highly required, which not only makes the cost of the camera module high, but also difficult to ensure reliability, and easily damaged in case of collision, drop, etc. Therefore, a new circuit design method is needed to reduce the cost of the camera module and improve the reliability of the camera module.

### SUMMARY OF THE PRESENT INVENTION

An object of the disclosure is to provide a base of a periscopic camera module, which can reduce the influence of setting circuit board on the internal space of the base, further simplify the internal structure of the base of the periscopic camera module, is beneficial to protect the circuit, and improve the structural reliability of the base.

Another object of the disclosure is to provide a manufacturing method, for manufacturing the base of the periscopic camera module described above.

Another object of the disclosure is to provide a periscopic camera module comprising the base of the periscopic camera module described above.

In order to achieve at least one of the above objects, the technical solution provided by the disclosure is that: a base of a periscopic camera module comprises: a housing comprising a bottom wall and a side wall located on a peripheral side of the bottom wall; a plurality of conductive members, each of the plurality of conductive members comprising a connecting branch embedded in the bottom wall and a mounting branch embedded in the side wall, the connecting branch and the mounting branch being interconnected, where the mounting branch comprises a first portion, a second portion, and a third portion distributed separately from each other on the side wall; an anti-shake coil, conductively connected to the first portion, where the anti-shake coil is parallel to a first optical axis of the periscopic camera module and perpendicular to a second optical axis of the periscopic camera module; and a focus coil, conductively connected to at least one of the second portion and the third portion, and disposed on different sides relative to the anti-shake coil.

As an option, the first portion, the second portion, and the third portion are respectively distributed on three peripheral sides of the connecting branch at intervals from each other, so as to be bent relative to the connecting branch without interfering with each other, to form an arrangement perpendicular to the connecting branch.

As an option, the base further comprises a controlling portion conductively connected to one of the second portion and the third portion, where the anti-shake coil and the focus coil are respectively conductively connected to the controlling portion via the connecting branch, so as to be controlled by the controlling portion.

As an option, the side wall comprises a first side wall, a second side wall, and a third side wall located on three peripheral sides of the bottom wall, the first side wall being parallel to the first optical axis of the periscopic camera module and perpendicular to the second optical axis of the periscopic camera module, the second side wall and the third side wall being facing to each other, where the first portion, the second portion, and the third portion are respectively embedded in the first side wall, the second side wall, and the third side wall.

As an option, each of the conductive members comprises at least two fixing ends located on the side wall and conductively connected to the mounting branch, and the fixing ends and the mounting branch are disposed on different surfaces, so that the mounting branch is embedded in the side wall and the fixing ends are exposed on the side wall.

As an option, the fixing end comprises a connecting end comprising a first connecting end connected to the first portion, and a second connecting end connected to at least one of the second portion and the third portion, the first connecting end is fixed to the anti-shake coil, and the second connecting end is fixed to the focus coil.

As an option, the connecting end comprises a third connecting end connected to the second portion and the third portion, and the third connecting end is exposed on an end of the side wall away from the side where the first portion is provided, and is adapted to be fixed to a photosensitive assembly of the periscopic camera module.

As an option, the base further comprises: a plurality of reinforcing members, embedded in the bottom wall, where the reinforcing members and the conductive members are positioned at intervals, each of the reinforcing members comprises a first reinforcing portion and a second reinforcing portion connected to each other, the first reinforcing portion and the second reinforcing portion are disposed on different surfaces, and the first reinforcing portion is adapted to support the second reinforcing portion, so that the second reinforcing portion and the connecting branch have partially overlapped projections along the first optical axis of the periscopic camera module.

As an option, the first reinforcing portion and the connecting branch are located in the same plane, and the first reinforcing portion and the connecting branch are positioned at intervals.

As an option, the reinforcing member comprises a first reinforcing member and/or a second reinforcing member, the first reinforcing member and the optical path turning portion of the periscopic camera module facing each other along the first optical axis, where at least part of the first reinforcing member forms a first magnetic sheet, so as to interact with an optical path magnet mounted on the optical path turning portion. The second reinforcing member and the lens portion of the periscopic camera module are facing each other along the first optical axis, and at least part of the second reinforcing member forms a second magnetic sheet, so as to interact with a lens magnet mounted on the lens portion.

As an option, the housing comprises a fixing portion covering at least part of the conductive members and at least part of the reinforcing member, so that the conductive members and the reinforcing member are positioned at intervals.

In order to achieve at least one of the above objects, the technical solution provided by the disclosure is that: a manufacturing method, for manufacturing the base of the periscopic camera module as described above, comprises steps of:
a, providing a first material strip for forming the conductive members, where each of the conductive members comprises a connecting branch and a mounting branch formed on at least three peripheral sides of the connecting branch, to form a first portion, a second portion and a third portion of the mounting branch, to obtain a first semi-finished product;
b, firstly injection molding on the first semi-finished product, to respectively form a first mounting portion, a second mounting portion, and a third mounting portion partially covering the first portion, the second portion, and the third portion, to obtain a second semi-finished product;
c, providing an anti-shake coil, a focus coil, and a controlling portion, to mount the anti-shake coil on the first portion, to mount the focus coil on at least one of the second mounting portion and the third mounting portion, and mount the controlling portion on one of the second mounting portion and the third mounting portion, to obtain a third semi-finished product;
d, bending the conductive members of the third semi-finished product, so that the mounting branch is bent in a vertical arrangement relative to the connecting branch, where the first mounting portion, the second mounting portion and the third mounting portion are bent relative to the connecting branch without interfering with each other, to obtain a fourth semi-finished product; and
e, secondly injection molding on the fourth semi-finished product, to connect the first mounting portion, the second mounting portion, and the third mounting portion separated from each other, to cover the rest of the conductive members, to form a molding portion, to obtain the base of the periscopic camera module.

As an option, the manufacturing method further comprises steps of: providing a second material strip, for forming a reinforcing member, to position the first material strip and the second material strip, so that the conductive members and the reinforcing member positioned at intervals, to obtain the first semi-finished product; and firstly injection molding on the first semi-finished product, to form a fixing portion fixing the reinforcing member and the conductive members, to hold the reinforcing member and the conductive members at intervals, to obtain the second semi-finished product.

In order to achieve at least one of the above objectives, the technical solution adopted by the disclosure is that: a periscopic camera module comprises: the base of the periscopic camera module as described above, where the base defines an accommodation space; an optical path turning portion, mounted in the accommodation space, the optical path turning portion and the anti-shake coil of the optical path turning portion facing each other along the second optical axis of the periscopic camera module, where the optical path turning portion is driven to perform an anti-shake motion; and a lens portion, mounted in the accommodation space, the lens portion and the focus coil of the lens portion facing each other along a third axis perpendicular to the first optical axis and the second optical axis of the periscopic camera module, where the lens portion is driven to perform a focus motion.

As an option, the periscopic camera module further comprises a photosensitive assembly, mounted on the base of the periscopic camera module and conductively connected to the controlling portion through the connecting end of the mounting branch exposed on the base of the periscopic camera module.

Compared with the related arts, the disclosure has the advantages that:
(1) The conductive members and the reinforcing members are embedded in the base together, which can enhance the structural reliability of the base on the basis of simplifying the circuit design, Moreover, the connecting branch of the conductive members are all located on the bottom wall and the mounting branch of the conductive members are all located on the side wall, so that the wiring distribution of the conductive members is more uniform, which is beneficial to avoid influencing the structural strength of the base by the wiring concentration in a certain part.
(2) Part of the reinforcing members can form magnetic sheets, which is beneficial to improving the positioning of the optical path turning portion and the lens portion of the periscopic camera module, thereby improving the imaging performance of the periscopic camera module. Part of the reinforcing members has functions of structural strengthening, thereby improving the impact resistance and the wear resistance of the base.
(3) Part of the fixing portion can fix the relative positional relationship of the connecting branch and the reinforcing member in the horizontal and/or vertical direction, so that the conductive members and the reinforcing members are positioned at intervals. Some of the fixing portion can fix the corners of the conductive members in the same plane, which is beneficial to avoid the deformation or damage of the conductive members.
(4) The fixing end and the mounting branch are disposed on different surfaces, so that the connecting branch and the mounting branch can be integrally covered inside the housing, and the fixing end is exposed from the housing to be adapted to connect to the electronic assembly, which is conducive to the surface flatness of the housing.
(5) Each of the conductive members has a connecting end and a controlling end respectively, so that each electronic component in the electronic assembly can be connected and conducted to the controlling portion respectively, which is beneficial to improving the reliability of circuit control.
(6) The electronic assembly is positioned and mounted by providing the mounting portion, and a protective structure for the electronic assembly is formed.

Another object of the disclosure is to provide a base of a periscopic camera module, where at least part of the conductive members of the periscopic camera module is embedded in the base, which is beneficial to simplify the circuit design and reduce the cost of the periscopic camera module, and can also protect the conductive members through the base, thereby improving the structural reliability of the circuit, and improving the reliability of the periscopic camera module.

Another object of the disclosure is to provide a base of a periscopic camera module, where the first group of conductive members and the second group of conductive members can be directly connected to the circuit board of the photosensitive assembly of the periscopic camera module respectively, so that the conventional integrated circuit board for controlling and driving the anti-shake coil and the focus coil arranged on the side wall of the base can be canceled, the part of the conductive member embedded on the bottom wall of the base can be reduced, and the complexity of the circuit can be reduced.

Accordingly, according to another embodiment of the disclosure, the base of the periscopic camera module, having at least one of the foregoing objects, comprises:
a housing, comprising a bottom wall and a plurality of side walls located on a peripheral side of the bottom wall;
a plurality of conductive members, embedded in the bottom wall and the plurality of side walls; and
a strengthening member, embedded in the base, spaced apart from the plurality of conductive members, and distributed on the plurality of side walls and the bottom wall, where in the bottom wall, the strengthening member is located outside the plurality of conductive members and extended to a corner of the base, where the reinforcing member and the plurality of conductive members are cut from the same material strip.

The above and other advantages of the disclosure will be fully apparent when taken in conjunction with the following description and the accompanying drawings.

The above and other advantages and features of the disclosure are fully demonstrated by the following detailed description of the disclosure and the accompanying drawings.

### BRIEF DESCRIPTION OF THE DRAWINGS

FIG. 1 is a perspective structural view of the periscopic camera module according to some embodiments of the disclosure.

FIG. 2 is a perspective structural view of the base of the periscopic camera module according to some embodiments of the disclosure.

FIG. 3 is a perspective structural view of the base of the periscopic camera module according to some embodiments of the disclosure.

FIG. 4 is a schematic structural view of the mounting portion and the fixing portion of the base of the periscopic camera module according to some embodiments of the disclosure.

FIG. 5 is a schematic structural view of the connecting branch and the reinforcing member on the bottom wall of the base of the periscopic camera module according to some embodiments of the disclosure.

FIG. 6 is a schematic structural diagram of the mounting portion and the fixing portion on the bottom wall of the base of the periscopic camera module according to some embodiments of the disclosure.

FIG. 7 is a sectional view of the periscopic camera module according to some embodiments of the disclosure along the first magnet.

FIG. 8 is a sectional view of the periscopic camera module according to some embodiments of the disclosure along the second magnet.

FIG. 9 is a sectional view of the periscopic camera module according to some embodiments of the disclosure along the guiding rail portion.

FIG. 10 is a schematic structural view of the first side wall of the base of the periscopic camera module according to some embodiments of the disclosure.

FIG. 11 is a schematic structural view of the first mounting portion on the first side wall of the base of the periscopic camera module according to some embodiments of the disclosure.

FIG. 12 is a rear perspective structural view of the optical path turning portion of the periscopic camera module according to some embodiments of the disclosure.

FIG. 13 is a bottom perspective structure view of the optical path turning portion of the periscopic camera module according to some embodiments of the disclosure.

FIG. 14 is a schematic structural view of the second side wall of the base of the periscopic camera module according to some embodiments of the disclosure.

FIG. 15 is a side perspective structural view of the lens portion of the periscopic camera module according to some embodiments of the disclosure.

FIG. 16 is a bottom perspective structural view of the lens portion of the periscopic camera module according to some embodiments of the disclosure.

FIG. 17 is a schematic perspective structural view of the third side wall of the base of the periscopic camera module according to some embodiments of the disclosure.

FIG. 18 is a schematic structural view of the third side wall of the base of the periscopic camera module according to some embodiments of the disclosure.

FIG. 19 is a schematic structural view of the mounting portion and the heightening portion on the bottom wall of the base of the periscopic camera module according to some embodiments of the disclosure.

FIG. 20 is a schematic perspective view of the periscopic camera module according to another embodiment of the disclosure.

FIG. 21 is a schematic perspective view of the base of the periscopic camera module according to another embodiment of the disclosure.

FIG. 22 is another perspective schematic view of the base of the periscopic camera module according to another embodiment of the disclosure.

FIG. 23 is a schematic perspective view of the conductive member of the base of the periscopic camera module according to another embodiment of the disclosure.

FIG. 24 is a schematic view of the first side portion of the first group of conductive members of the base of the periscopic camera module according to another embodiment of the disclosure.

FIG. 25 is a schematic view of the second group of conductive members of the base of the periscopic camera module according to another embodiment of the disclosure.

FIG. 26 is a schematic view of the foundation portion of a first group of conductive members of the base of the periscopic camera module according to another embodiment of the disclosure.

FIG. 27 is a schematic view of the planar layout pattern of the first group of conductive members, the second group of conductive members, and the strengthening member in the material strip according to another embodiment of the disclosure.

FIG. 28 is a schematic view of the conductive connection relationship between the circuit board of the electronic assembly and the photosensitive assembly according to another embodiment of the disclosure.

FIG. 29 is a schematic perspective view of the strengthening member according to another embodiment of the disclosure.

FIG. 30 is a schematic view of the base held in the material strip according to another embodiment of the disclosure.

FIG. 31 is a schematic view of the holding end according to another embodiment of the disclosure.

FIG. 32 is a schematic view of the optical path turning portion of the periscopic camera module according to another embodiment of the disclosure.

FIG. 33 is another schematic view of the optical path turning portion of the periscopic camera module according to another embodiment of the disclosure.

FIG. 34 is another schematic view of the optical path turning portion of the periscopic camera module according to another embodiment of the disclosure.

FIG. 35 is another schematic view of the lens portion of the periscopic camera module according to another embodiment of the disclosure.

FIG. 36 is another schematic view of the lens portion of the periscopic camera module according to another embodiment of the disclosure.

### DETAILED DESCRIPTION OF THE PREFERRED EMBODIMENT

Hereinafter, the disclosure will be further described in conjunction with the specific embodiments, and it should be noted that the embodiments described below or the technical features can be arbitrarily combined to form new embodiments on the premise of no conflict.

In the description of the disclosure, it should be noted that the terms such as “center”, “lateral”, “longitudinal”, “longitudinal”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, etc. are based on the orientation or positional relationship shown in the drawings. It is intended only to facilitate the description of the present disclosure and to simplify the description, and is not intended to indicate or imply that the referred to devices or elements must have a specific orientation, be constructed and operate in a specific orientation, and should not be construed as limiting the specific scope of protection of the present disclosure.

It should be noted that the terms “first”, “second”, and the like in the specification and claims of the present disclosure are used to distinguish similar objects, and are not necessarily used to describe a specific order or sequence.

The terms “comprise” and “have” and any variations thereof in the specification and claims of this application are intended to cover non-exclusive inclusion, for example, a process, method, system, product, or apparatus comprising a series of steps or units need not be limited to those steps or units clearly listed, but may comprise other steps or units not clearly listed or inherent to such processes, methods, products, or devices.

In the description of the disclosure, it should also be noted that unless otherwise explicitly specified and defined, the terms “provided”, “mounted”, “connected”, and “disposed” should be understood in a broad sense, for example, fixed connection, detachable connection, or integral connection. The connection can be mechanical or electrical. It can be directly connected, contact connection or indirectly connected through an intermediate medium, and it can be the internal communication of the two elements. For one having skills in the arts, the specific meanings of the above terms in the disclosure can be understood according to the specific circumstances.

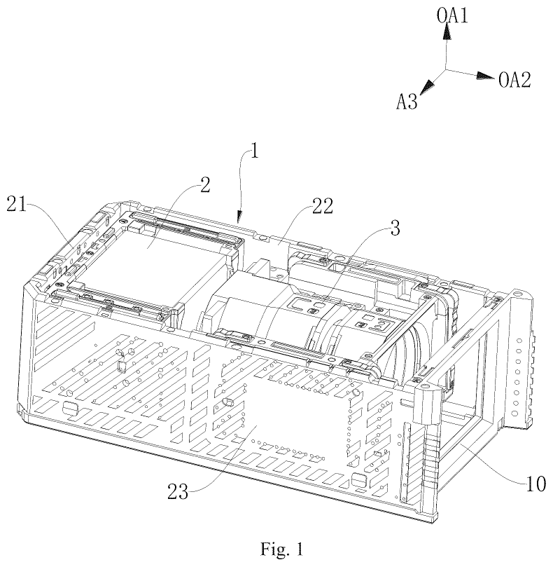

Referring to FIGS. 1 to 4 of the drawings of the specification of the disclosure, a base of a periscopic camera module according to some embodiments of the disclosure is illustrated, which comprises a housing 1 comprising a bottom wall 10 and a plurality of side walls 20 located on the peripheral side of the bottom wall 10. An accommodation space 24 is formed between the bottom wall 10 and the side walls 20 for accommodating an optical path turning portion 2 and a lens portion 3 of the periscopic camera module. The base further comprises a plurality of conductive members 70, the conductive members 70 comprises a connecting branch 71 embedded in the bottom wall 10 and a mounting branch 72 embedded in the side wall 20, and the connecting branch 71 and the mounting branch 72 are connected and conducted to each other.

The mounting branch 72 comprises at least three portions distributed on at least three peripheral sides of the connecting branch 71, namely a first portion 721, a second portion 722, and a third portion 723 respectively. That is, the first portion 721, the second portion 722, and the third portion 723 are distributed on the side wall 20 separately from each other. It will be understood that the first portion 721, the second portion 722, and the third portion 723 are spaced apart from each other, so as to be adapted to be bent relative to the connecting branch 71 without interfering with each other. After bending, the first portion 721, the second portion 722, and the third portion 723 are vertically arranged and independent of each other. In this way, the wiring of the conductive member 70 is concentrated and easily bent, and since the connecting branch 71 can be used as the basis of the positioning support during bending, the risk of deformation and dislocation generated during bending the conductive member 70 can be reduced, the process difficulty can be reduced, and the production yield rate can be improved.

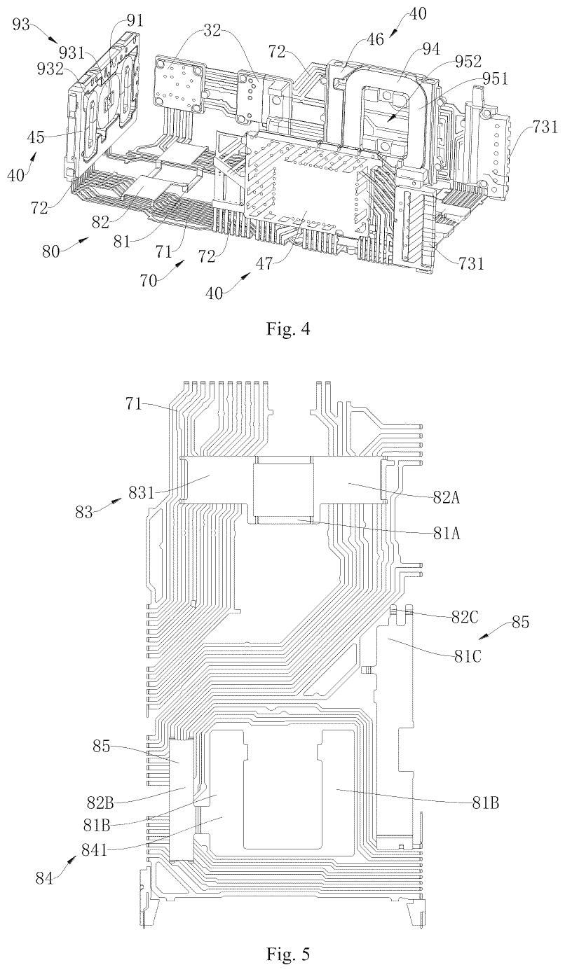

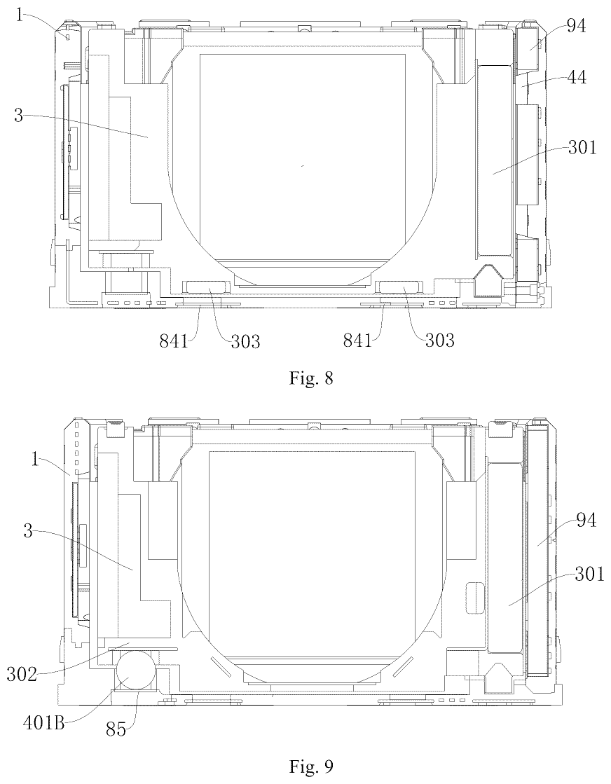

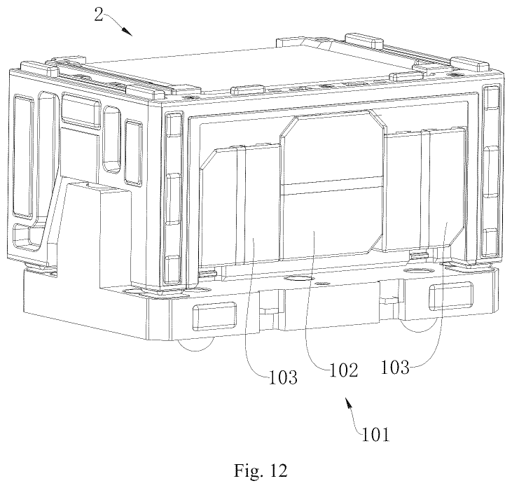

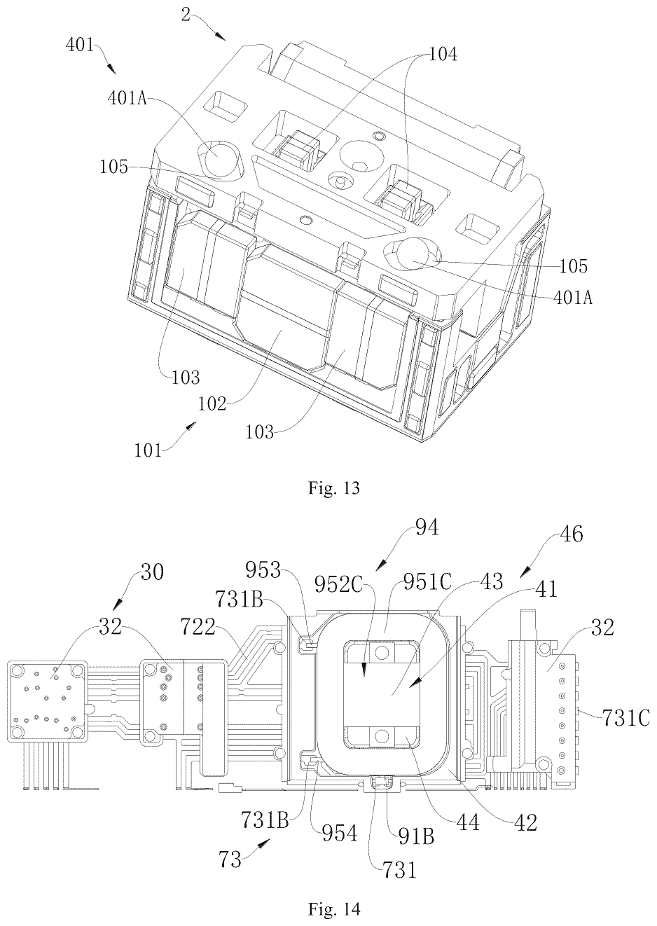

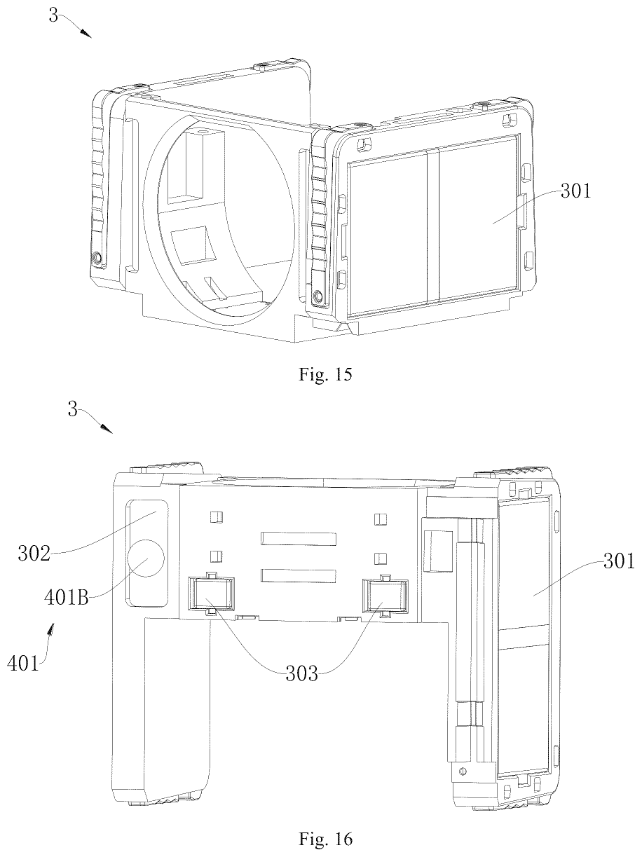

Further, as shown in FIGS. 4 to 18, each of the conductive members 70 further comprises at least two fixing ends 73 located on the side wall 20. The fixing ends 73 and the mounting branch 72 are conductively connected to each other, and the fixing ends 73 and the mounting branch 72 are arranged on different surfaces, so that the mounting branch 72 is embedded in the side wall 20, and the fixing ends 73 are exposed on the side wall 20. That is, the conductive member 70 comprises a connecting branch 71 located on the bottom wall 10, a mounting branch 72 located on the side wall 20, and a fixing end 73 located on the side wall 20 and connected and conducted with the mounting branch 72. The connecting branch 71 is embedded in the bottom wall 10, the mounting branch 72 is embedded in the side wall 20, and the fixing end 73 and the mounting branch 72 are disposed on different surfaces, so as to be exposed on the side wall 20 and connected to an electronic assembly 90.

It can be understood that the connecting branch 71 and the mounting branch 72 of the conductive member 70 are integrally covered in the bottom wall 10 and the side wall 20 of the housing 1, so that the positioning and the protection of the connecting branch 71 and the mounting branch 72 can be realized by the housing 1, which is beneficial to reduce the risk of damage of the conductive member 70 when impacted by an external force, and thus can improve the reliability of the circuit of the periscopic camera module. Also, the fixing end 73 is exposed from the side wall 20 of the housing 1 by being arranged on a different surface from the mounting branch 72, and is adapted for connecting to the electronic assembly 90, so as to avoid opening a recessed avoidance area on the side wall 20 to expose the fixing end 73, which is beneficial to simplifying the structure of the side wall 20, making the surface of the side wall 20 flat, further reducing structural abrupt change on the housing 1, reducing stress concentration, and improving the structural strength of the housing 1.

Specifically, as illustrated in FIGS. 11, 14, 17, and 18, the electronic assembly 90 comprises an anti-shake coil 93, a focus coil 94, a sensing component 91, an external circuit, and a controlling portion 92. The anti-shake coil 93 interacts with the anti-shake magnet 101 mounted on the optical path turning portion 2, to drive the optical path turning portion 2 to swing about the first optical axis OA1 or to pitch about the third axis A3. The focus coil 94 interacts with a focus magnet 301 mounted on the lens portion 3, to drive the lens portion 3 to move along the second optical axis OA2. The sensing component 91 comprises a first sensing component 91A for sensing the position of the optical path turning portion 2 and a second sensing component 91B for sensing the position of the lens portion 3. The external circuit comprises an electronic component such as a photosensitive assembly located outside the accommodation space 24 of the housing 1. The controlling portion 92 controls the anti-shake coil 93, the focus coil 94, and the sensing component 91. The first optical axis OA1 refers to the center line of the light incident on the periscopic camera module, the second optical axis OA2 refers to the center line of the light emitted from the periscopic camera module, and the third axis A3 is orthogonal to the first optical axis OA1 and the second optical axis OA2.

Further, as shown in FIGS. 11, 14, 17, and 18, the fixing end 73 comprises a connecting end 731 adapted to be connected and conducted with the anti-shake coil 93, the focus coil 94, the sensing component 91, and the external circuit in the electronic assembly 90, and a controlling end 732 adapted to be conducted and connected with the controlling portion 92 in the electronic assembly 90.

Specifically, each of the conductive members 70 has a controlling end 732 and at least one connecting end 731, and the controlling end 732 and the connecting end 731 are embedded in the side wall 20 of the housing 1. A part of the branch body of the conductive member 70 located on the side wall 20 forms the mounting branch 72, one end of each mounting branch 72 is connected to the connecting end 731 or the controlling end 732, and a part of the branch body of the conductive member 70 located on the bottom wall 10 forms the connecting branch 71, and two ends of the connecting branch 71 are respectively correspondingly connected to the mounting branch 72. It can be understood that when the connecting end 731 and the controlling end 732 are disposed on different surfaces, that is, the connecting end 731 and the controlling end 732 are located on the side walls 20 in different directions. The branch body of the conductive member 70 extends from the controlling end 732 along one of the side walls 20 to the bottom wall 10, and then extends along the bottom wall 10 to the connecting end 731 on the other side wall 20. Further, each of the anti-shake coils 93, each of the focus coils 94, or each of the sensing components 91 in the electronic assembly 90 is connected and conducted to the controlling portion 92 through the conductive members 70, and is controlled by the controlling portion 92, which is beneficial to improve the reliability of circuit control of the periscopic camera module.

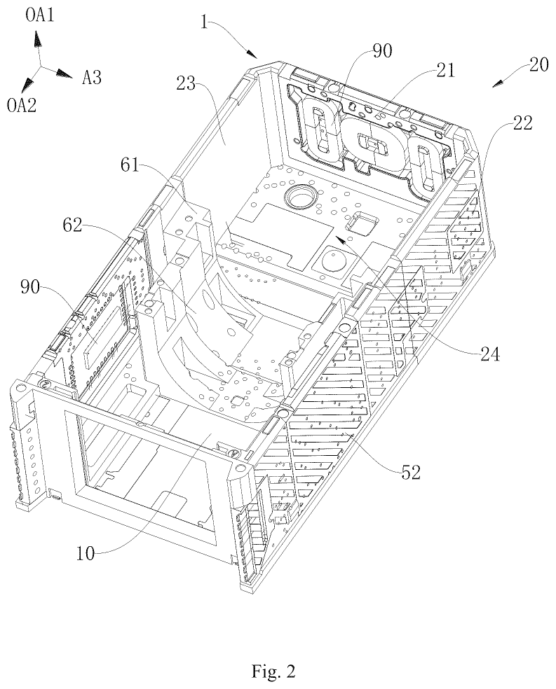

As shown in FIGS. 2 to 4, the housing 1 has a substantially rectangular bottom wall 10 and side walls 20 located on a peripheral side of the bottom wall 10. The side walls 20 comprise a first side wall 21, a second side wall 22 and a third side wall 23, the second side wall 22 and the third side wall 23 are facing each other on two sides of the bottom wall 10 along the third axis A3, and the first side wall 21 is perpendicular to the second optical axis OA2 and located between the second side wall 22 and the third side wall 23.

Further, the accommodation space 24 is formed between the first side wall 21, the second side wall 22, the third side wall 23, and the bottom wall 10 for accommodating the optical path turning portion 2 and the lens portion 3. Further, the lens portion 3 is disposed between the second side wall 22 and the third side wall 23, and is adapted to move along the second optical axis OA2. The optical path turning portion 2 is located between the lens portion 3 and the first side wall 21, and is adapted to pitch about the third axis A3 and swing about the first optical axis OA1.

Further, the first portion 721 of the mounting branch 72 is embedded in the first side wall 21, the second portion 722 is embedded in the second side wall 22, and the third portion 723 is embedded in the third side wall 23. The connecting end 731 comprises a first connecting end 731A and a second connecting end 731B, and the first connecting end 731A is connected to the first portion 721 for fixing to the anti-shake coil 93. The second connecting end 731B is connected to at least one of the second portion 722 and the third portion 723 for fixing to the focus coil 94.

Further, the connecting end 731 further comprises a third connecting end 731C connected to the second portion 722 and the third portion 723, and the third connecting end 731C is exposed on an end of the side wall 20 away from the side provided with the first portion 721, for fixing to the photosensitive assembly of the periscopic camera module.

It is worth mentioning that, compared with the third connecting end 731C that integrally extends from one end of the second side wall 22 and one end of the third side wall 23, in the embodiment, the third connecting end 731C is integrally embedded in the side wall 20 and is connected to an external circuit only through an exposed surface, so that the third connecting end 731C can be fixed and protected by the second side wall 22 and the third side wall 23 of the housing 1, which is beneficial to reduce the risk of deformation or even fracture of the third connecting end 731C.

Optionally, the third connecting end 731C is exposed on two sides of the second side wall 22 and the third side wall 23 facing away from each other, that is, the third connecting end 731C is exposed on the outside surface of the second side wall 22 and the outside surface of the third side wall 23, so as to conducive to conductive connection with the external circuit.

In a specific embodiment, the anti-shake coil 93 for driving the optical path turning portion 2 is located on the first side wall 21 of the housing 1, and is parallel to the first optical axis OA1 and perpendicular to the second optical axis OA2. The first connecting ends 731A of the conductive members 70 conductively connected to the anti-shake coil 93 are located on the first side wall 21 of the housing 1. The focus coil 94 for driving the lens portion 3 to move is located on the second side wall 22 of the housing 1, the second connecting ends 731B of the conductive members 70 conductively connected to the focus coil 94 are located on the second side wall 22 of the housing 1, the controlling portion 92 for controlling the anti-shake coil 93 and the focus coil 94 is located on the third side wall 23 of the housing 1, and the controlling ends 732 of the conductive members 70 connected with the controlling portion 92 are located on the third side wall 23.

As mentioned above, the first portion 721, the second portion 722, and the third portion 723 of the mounting branch 72 are respectively formed on three peripheral sides of the connecting branch 71, to be adapted to mount the anti-shake coil 93, the focus coil 94, and the controlling portion 92. In this way, the wiring of the periscopic camera module of the present disclosure is concentrated, and the circuit design is simplified.

Further, during bending the conductive member 70, the mounting branch 72 is bent in a vertically arranged state with the connecting branch 71 as a basis. Since there are a certain number of connecting branches 71, a certain support and positioning are provided during bending, and the risk of deformation, dislocation, or the like between the mounting branch 72 and the connecting branch 71 due to bending is reduced. Moreover, there is no other connecting portion other than the connecting branch 71 on the basis between each portion of the mounting branch 72 to be bent, so that the mounting branch 72 of each portion is relatively independent and does not interfere with each other during bending, and it is only necessary to bend each portion of the mounting branch 72 to change from the horizontal state to the vertical state, the bending process is relatively simple, and problems such as deformation and dislocation are not easy to occur, which is beneficial to improving the yield. Each portion of the mounting branch 72 after bending is independent of each other in the vertical direction.

In some embodiments, the base further comprises a reinforcing member 80 embedded in the bottom wall 10, and the reinforcing member 80 and the conductive members 70 are disposed at intervals. Each reinforcing member 80 comprises a first reinforcing portion 81 and a second reinforcing portion 82 connected to each other, the first reinforcing portion 81 and the second reinforcing portion 82 disposed on different surfaces, the first reinforcing portion 81 being adapted to support the second reinforcing portion 82 such that the second reinforcing portion 82 and the connecting branch 71 have partially overlapped projections along the first optical axis OA1.

That is, the conductive member 70 and the reinforcing member 80 are embedded in the housing 1, and the connecting branch 71 of each conductive member 70 and the reinforcing member 80 are located on the bottom wall 10, the mounting branch 72 of each conductive member 70 is located on the side wall 20, and the mounting branch 72 located on the side wall 20 and the connecting branch 71 located on the bottom surface are connected and conducted to each other. It can be understood that the conductive member 70 and the reinforcing member 80 are embedded in the base together, to enhance the structural reliability of the base on the basis of simplifying the circuit design. Moreover, the connecting branch 71 of the conductive member 70 is located on the bottom wall 10, and the mounting branch 72 is located on the side wall 20, so that the wiring distribution of the conductive members 70 is more uniform, which is beneficial to avoid the wiring concentration of a certain part of the housing 1 and affecting the structural strength of the base.

Optionally, the first reinforcing portion 81 and the connecting branch 71 are located in the same plane, so that it is convenient to place the reinforcing member 80 and the conductive member 70 during injection molding, and the first reinforcing portion 81 and the connecting branch 71 are positioned at intervals, that is, the first reinforcing portion 81 is located in the gap between the two connecting branches 71 to avoid contact and conduction of the reinforcing member 80 and the connecting branch 71, thereby improving the reliability of the circuit of the base.

In some embodiments, as shown in FIGS. 5 to 9, the reinforcing member 80 comprises a first reinforcing member 83, the first reinforcing member 83 and the optical path turning portion 2 of the periscopic camera module facing each other along the first optical axis OA1, and at least part of the first reinforcing member 83 forms a first magnetic sheet 831 to interact with the first magnet 104 mounted on the optical path turning portion 2, which is beneficial to improving the positioning of the optical path turning portion 2 and further improving the imaging performance of the periscopic camera module.

In a specific embodiment, as shown in FIGS. 5 to 7, the first reinforcing member 83 comprises a first reinforcing unit 81A and a fourth reinforcing unit 82A, where the first reinforcing unit 81A and the connecting branch 71 of the conductive member 70 are located on the same plane and are positioned at intervals, and the first reinforcing unit 81A and the fourth reinforcing unit 82A are disposed on different surfaces to support the fourth reinforcing unit 82A, so that the fourth reinforcing unit 82A is disposed above a plurality of connecting branches 71 to form the first magnetic sheet 831. Further, the first magnetic sheet 831 is facing the first magnet 104 on the bottom surface of the optical path turning portion 2 along the first optical axis OA1, to interact with the first magnet 104, to attract the optical path turning portion 2 and the housing 1, thereby clamping a supporting member 401 between the optical path turning portion 2 and the housing 1 to avoid detachment of the supporting member 401, and the optical path turning portion 2 is driven to be reset by interacting with the first magnetic sheet 831 and the first magnet 104.

The supporting member 401 comprises a first supporting member 401A disposed between a first guiding rail portion 105 of the optical path turning portion 2 and the bottom wall 10. In a case where the anti-shake coil 93 and the anti-shake magnet 101 interact with each other, the first supporting member 401A supports the optical path turning portion 2 to move relative to the housing 1. By the magnetic attraction of the first magnet 104 and the first magnetic sheet 831, a pre-pressure is generated, so that the optical path turning portion 2 is held on the housing 1 and the first supporting member 401A is prevented from being detached. Further, after the movement of the optical path turning portion 2, the optical path turning portion 2 can be reset by the magnetic attraction of the first magnet 104 and the first magnetic sheet 831. The first supporting member 401A can be implemented as a ball.

It is worth mentioning that the bottom of the optical path turning portion 2 can have two first magnets 104 positioned at intervals along the third axis A3, so that the attraction force distribution between the optical path turning portion 2 and the housing 1 can be more uniform, and the structural reliability of the periscopic camera module can be improved.

In a specific embodiment, one first reinforcing member 83 has two fourth reinforcing units 82A positioned at intervals, and the two fourth reinforcing units 82A are connected and supported by a plurality of first reinforcing units 81A. It can be understood that the two fourth reinforcing units 82A can respectively form the two first magnetic sheets 831, and then each first magnetic sheet 831 corresponds to one first magnet 104 along the first optical axis OA1, thereby improving the reliability of interaction between the first magnetic sheet 831 and the first magnet 104. Further, the two first magnetic sheets 831 are symmetrically disposed with the first optical axis OA1 as the symmetry axis. The two corresponding first magnets 104 are symmetrically disposed with the first optical axis OA1 as the symmetry axis, so that two sides of the optical path turning portion 2 with the first optical axis OA1 as the symmetry axis are balanced by the magnetic attraction force, and a balanced pre-pressure is generated.

In another embodiment, the two first magnetic sheets 831 are formed by one first reinforcing member 83, that is, the first reinforcing member 83 has one fourth reinforcing unit 82A to form one first magnetic sheet 831, and the two first magnetic sheets 831 positioned at intervals are formed by arranging the two first reinforcing members 83 at intervals.

It can be understood that the fourth reinforcing unit 82A of the first reinforcing member 83 is extended along the third axis A3, so that the first magnetic sheet 831 has a certain length along the third axis A3, and can be adapted to the movement stroke of the optical path turning portion 2, so that during the movement of the optical path turning portion 2, the first magnetic sheet 831 and the first magnet 104 can continuously generate magnetic attraction, and maintain a state in which a pre-pressure is generated between the optical path turning portion 2 and the bottom wall 10 of the housing 1, so as to prevent the first supporting member 401A from being detached.

Further, as shown in FIGS. 5, 6, and 8, the reinforcing member 80 further comprises a second reinforcing member 84, the second reinforcing member 84 and the lens portion 3 of the periscopic camera module facing each other along the first optical axis OA1, and at least part of the second reinforcing member 84 forms a second magnetic sheet 841 to interact with the second magnet 303 mounted at the bottom of the lens portion 3, which is beneficial to improve the positioning of the lens portion 3 and further improve the imaging performance of the periscopic camera module.

Further, as shown in FIGS. 5, 6, and 9, the reinforcing member 80 comprises a third reinforcing member 85, at least part of the third reinforcing member 85 and the second guiding rail portion 302 of the lens portion 3 facing each other along the first optical axis OA1. It can be understood that the supporting member 401 comprises a second supporting member 401B disposed between the second guiding rail portion 302 of the lens portion 3 and the bottom wall 10 of the base, to support the movement of the lens portion 3 relative to the bottom wall 10 of the housing 1. It can be understood that the third reinforcing member 85 embedded in the bottom wall 10 and disposed facing the second guiding rail portion 302 along the first optical axis OA1 can enhance the structural strength of the bottom wall 10, which is beneficial to improving the structural reliability of the base, and thus extending the service life of the base.

In some embodiments, the third reinforcing member 85 is completely embedded in the bottom wall 10, which improves the structural reliability and the impact resistance of the bottom wall 10 of the base, and is beneficial to reduce the risk of cracking of the bottom wall 10 due to impact. In other embodiments, at least part of the third reinforcing member 85 is exposed on the surface of the bottom wall 10 to be in contact with the second supporting member 401B, thereby improving the wear resistance of the bottom wall 10, and in a case where the third reinforcing member 85 is exposed on the bottom wall 10, thereby improving the levelness of the bottom wall 10, which facilitates the horizontal movement of the second supporting member 401B.

It is worth mentioning that, in a specific embodiment, as shown in FIG. 5, the second reinforcing member 84 and the third reinforcing member 85 are one same element, so that the structure of the base is more compact. The second reinforcing unit 81B of the second reinforcing member 84 is facing the second magnet 303 on the lens portion 3 along the first optical axis OA1, to form the second magnetic sheet 841. Further, a fifth reinforcing unit 82B is connected to at least one side of the second reinforcing unit 81B, and the second reinforcing unit 81B supports the fifth reinforcing unit 82B, so that the fifth reinforcing unit 82B is exposed above the bottom wall 10 and is facing the second guiding rail portion 302 of the lens portion 3 along the first optical axis OA1.

Specifically, the bottom of the lens portion 3 comprises two second magnets 303 positioned at intervals along the third axis A3, so that the attractive force distribution between the lens portion 3 and the housing 1 can be more uniform and the structural reliability of the periscopic camera module can be improved. The second reinforcing unit 81B forms two second magnetic sheets 841 positioned at intervals along the third axis A3 and extended along the second optical axis OA2, so that in a case where the lens portion 3 moves along the second optical axis OA2, the second magnetic sheets 841 can cover the movement range of the second magnet 303 on the lens portion 3.

It can be understood that the second supporting member 401B can be designed as a ball adapted to be clamped between the second guiding rail portion 302 and the fifth reinforcing unit 82B to support the movement of the lens portion 3. The second supporting member 401B can further be implemented as a guiding rod adapted to be clamped between the second guiding rail portion 302 and the fifth reinforcing unit 82B to support movement of the lens portion 3.

In some embodiments, the second supporting member 401B can be disposed between two corresponding sides of the bottom of the lens portion 3 and two second guiding rail portions 302 provided on two sides of the housing 1. Further, the second supporting member 401B on two sides can be implemented as balls or guiding rails, or the second supporting member 401B on one side can be implemented as a ball, and the second supporting member 401B on the other side can be implemented as a guiding rod. In another embodiment, the second supporting member 401B can be disposed between one side of the bottom of the lens portion 3 and the second guiding rail portion 302 on one side of the housing 1.

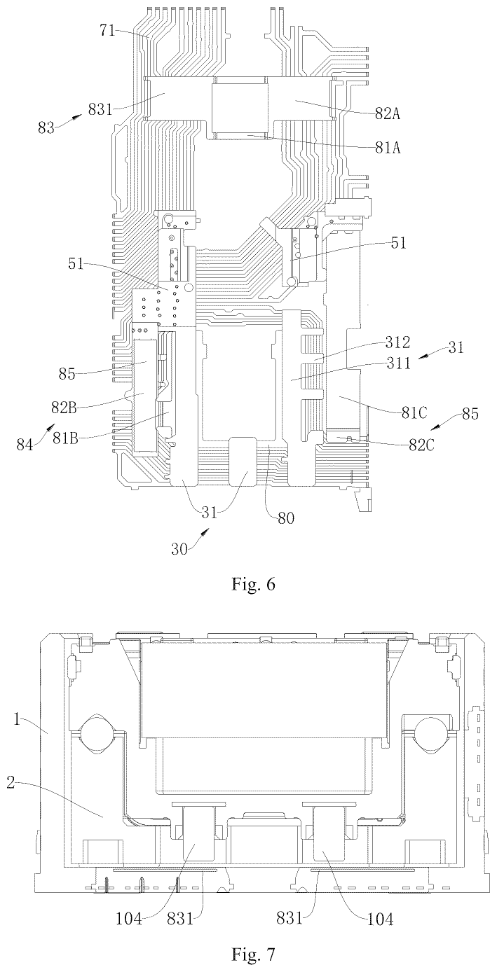

More specifically, as shown in FIGS. 5 and 6, in a case where the second supporting member 401B on one side of the lens portion 3 is implemented as a ball and the second supporting member 401B on the other side is implemented as a guiding rod, the bottom surface of the lens portion 3 has a second guiding rail portion 302, and one side of the second reinforcing unit 81B is connected to the fifth reinforcing unit 82B facing to the second guiding rail portion 302 along the first optical axis OA1, the fifth reinforcing unit 82B is extended along the second optical axis OA2 to cover the movement range of the ball of the lens portion 3, and the fifth reinforcing unit 82B is exposed on the surface of the bottom wall 10 to improve the wear resistance of the base. The other side of the base is provided with the third reinforcing member 85 facing to the guiding rod along the first optical axis OA1, the third reinforcing unit 81C of the third reinforcing member 85 is extended along the second optical axis OA2 to cover the movement range of the guiding rod, and the third reinforcing unit 81C is embedded in the bottom wall 10 to increase the structural strength, and the sixth reinforcing units 82C of the third reinforcing member 85 are located at two ends of the third reinforcing unit 81C.

In a case where the lens portion 3 is in the form of two-sides-support, the bottom surface of the lens portion 3 has two second guiding rail portions 302 positioned at intervals along the third axis A3, and further each of the two sides of the second reinforcing unit 81B is connected to one fifth reinforcing unit 82B, and the fifth reinforcing unit 82B is extended along the second optical axis OA2 to cover the movement range of the second supporting member 401B of the lens portion 3.

It can be understood that the second reinforcing member 84 and the third reinforcing member 85 can further be provided separately, which is beneficial to simplify the structure of the second reinforcing member 84 and the third reinforcing member 85.

It is worth mentioning that the material of each reinforcing member 80 is a material having magnetic permeability, so as to be adapted for forming the first magnetic sheet 831 and the second magnetic sheet 841, and further generate a magnetic attraction action with the first magnet 104 on the optical path turning portion 2 and the second magnet 303 on the lens portion 3, which is beneficial for driving the optical path turning portion 2 and the lens portion 3 to reset, and forming a clamping action on the supporting member 401. Further, the material of each reinforcing member 80 is a material having a certain rigidity and strength, so that the structural strength of the bottom wall 10 can be improved. Optionally, the material of the reinforcing member 80 is magnetically permeable stainless steel.

Further, the material of the conductive member 70 is a material having good electrical conductivity, weak or even no magnetic conductivity, which is beneficial to reduce interference between the magnetic field of the conductive member 70 and the magnetic field of the reinforcing member 80.

In some embodiments, as shown in FIGS. 4, 6, 14, 17, and 18, the housing 1 comprises a fixing portion 30 covering at least part of the conductive members 70 and at least part of the reinforcing members 80, so that the conductive members 70 and the reinforcing members 80 are positioned at intervals. It can be understood that the fixing portion 30 can preliminarily fix the relative positions of the conductive members 70 and the reinforcing members 80, which is beneficial to avoid relative movement between the conductive members 70 and the reinforcing members 80 in the subsequent process, reduces the risk of mutual contact between the conductive members 70 and the reinforcing members 80, and thus is beneficial to improving the reliability of the circuit of the periscopic camera module.

Specifically, as shown in FIG. 4, the fixing portion 30 comprises a plurality of first fixing portions 31, each of the first fixing portions 31 covers at least part of the connecting branch 71 and at least part of the first reinforcing portion 81, so that the connecting branch 71 and the first reinforcing portion 81 are positioned at intervals in the bottom wall 10, and/or covers at least part of the connecting branch 71 and at least part of the second reinforcing portion 82, so that the connecting branch 71 and the second reinforcing portion 82 are positioned at intervals along the first optical axis OA1. That is, the first fixing portion 31 can fix the relative positions of the connecting branch 71 and the reinforcing members 80 in the horizontal direction perpendicular to the first optical axis OA1 and/or in the vertical direction along the first optical axis OA1, so that the conductive members 70 and the reinforcing members 80 are positioned at intervals.

Further, as shown in FIG. 6, in a case where the first reinforcing portion 81 or the second reinforcing portion 82 of the reinforcing member 80 is extended for a long length in the horizontal direction perpendicular to the first optical axis OA1, the first fixing portion 31 comprises a first extending structure 311 covering the reinforcing member 80 and a plurality of second extending structures 312 covering the connecting branch 71. The first extending structure 311 is adapted to extend along the length direction of the first reinforcing portion 81 or the second reinforcing portion 82, to cover at least part of the surface of the first reinforcing portion 81 or the second reinforcing portion 82, thereby protecting the first reinforcing portion 81 or the second reinforcing portion 82, which is beneficial to reduce the risk of deformation of the reinforcing portion 80 in subsequent processes. The plurality of second extending structures 312 are positioned at intervals along the extending direction of the first extending structure 311 and cover the connecting branch 71, so that the connecting branch 71 of the conductive member 70 and the reinforcing member 80 are positioned at intervals in the horizontal direction.

Optionally, the second extending structure 312 is protruded from one side of the first extending structure 311 along the direction vertical to the connecting branch 71, and covers the connecting branch 71 of at least two conductive members 70. In a case where the reinforcing member 80 and/or the connecting branch 71 is applied with an external force pulling, the external force can be distributed to the connecting branch 71 of the plurality of conductive members 70, which is beneficial to improving the ability to bear the external force pulling, and further improving the structural strength of the base and the reliability of the circuit.

Further, as shown in FIG. 14, the fixing portion 30 further comprises a plurality of second fixing portions 32, and each of the second fixing portions 32 covers a corner of the connecting branch 71 or a corner of the mounting branch 72, which is beneficial to avoid deformation or damage of the conductive members 70. It can be understood that the stiffness of the corner of the connecting branch 71 and the corner of the mounting branch 72 is low, and deformation is easy to occur in the subsequent process, and the second fixing portions 32 are provided at the corners to fix the relative position between the connecting branch 71 at the corners or the relative position between the mounting branch 72 at the corners, so as to avoid the connecting branch 71 between the conductive members 70 or the mounting branch 72 between the conductive members 70 from being deformed and from being contacting and conducting each other at the corner, which is beneficial to improving the reliability of the circuit of the base.

It is worth mentioning that the connecting branch 71 is located on the bottom wall 10 and the mounting branch 72 is located on the side wall 20, so that the second fixing portion 32 provided at the corner of the connecting branch 71 and the second fixing portion 32 provided at the corner of the mounting branch 72 are separated from each other, and the second fixing portions 32 provided at the corner of the mounting branch 72 of different side walls 20 are also separated from each other, so as to avoid affecting the bending of the conductive members 70 in the subsequent process.

It can be understood that the first fixing portion 31 and the second fixing portion 32 can be separately provided at intervals, and the first fixing portion 31 and the second fixing portion 32 can be connected to each other to be integrally molded, to which the present disclosure does not specifically limit.

In some embodiments, as shown in FIG. 4, the housing 1 further comprises a plurality of mounting portions 40 located on the side wall 20, the mounting portions 40 covering a part of the mounting branch 72 of the conductive member 70, and the middle area of the mounting portions 40 has a recess 41 for accommodating the electronic assembly 90. Specifically, the mounting portion 40 comprises a peripheral wall 42 and a bottom plate 43. The recess 41 is defined between the peripheral wall 42 and the bottom plate 43. The bottom plate 43 covers a part of the mounting branch 72 of the conductive members 70, thereby fixing and protecting the mounting branch 72 of the conductive member 70, and further isolating the electronic assembly 90 from the mounting branch 72. Further, the fixing end 73 of the conductive member 70 is exposed on the surface of the bottom plate 43, and conductively connected to the electronic assembly 90 mounted on the bottom plate 43.

It can be understood that, as described above, by arranging the fixing end 73 and the mounting branch 72 on different surfaces, the fixing end 73 can be exposed from the bottom plate 43 and adapted to be connected to the electronic assembly 90, thereby avoiding opening a recessed avoidance area on the bottom plate 43 to expose the fixing end 73, which is beneficial to simplifying the structure of the mounting portion 40, making the surface of the bottom plate 43 flat, further reducing structural abrupt changes on the mounting portion 40, reducing stress concentration, and improving the structural strength of the mounting portion 40.

Further, as shown in FIGS. 11 and 14, pairs of protruding posts 44 are provided in the recess 41 of the mounting portion 40, for positioning and mounting the anti-shake coil 93 or the focus coil 94. Specifically, each of the anti-shake coils 93 and each of the focus coils 94 has a coil body 951, a positive lead end 953, and a negative lead end 954 led out from the coil body 951. The inner wall of the coil body 951 defines a mounting hole 952, so that the coil body 951 is sleeved on the protruding post 44, and the positive lead end 953 and the negative lead end 954 are adapted to be connected and conducted with the connecting ends 731 of the conductive members 70 respectively to realize energization, and then can be matched with the anti-shake magnet 101 or the focus magnet 301 to drive the optical path turning portion 2 and the lens portion 3 to move in the base.

It is worth mentioning that during mounting the anti-shake coil 93 and the focus coil 94, the coil body 951 can be formed by winding around the two protruding posts 44 disposed oppositely with one of the coil positive lead end 953 or the negative lead end 954 as a starting end, and the winding can be stopped with the other of the negative lead end 954 or the negative lead end 954 as an end portion. The coil can be wound in advance, and the wound coil can be sleeved on the protruding posts 44.

Further, the height of the protruding post 44 and/or the height of the peripheral wall 42 are greater than the height of the anti-shake coil 93 and the focus coil 94 to protect the anti-shake coil 93 and the focus coil 94. That is, in a case where the coil bodies 951 of the anti-shake coil 93 and the focus coil 94 are mounted on the protruding posts 44, the coil body 951 abuts against the bottom plate 43, and the extension height of the protruding post 44 and/or the extension height of the peripheral wall 42 in the direction perpendicular to the bottom plate 43 is larger than the height of the coil body 951, which is beneficial to avoid interference with the coil body 951 by the optical path turning portion 2 and the lens portion 3 moving in the base, and thus reduce the risk of damage of the anti-shake coil 93 and the focus coil 94.

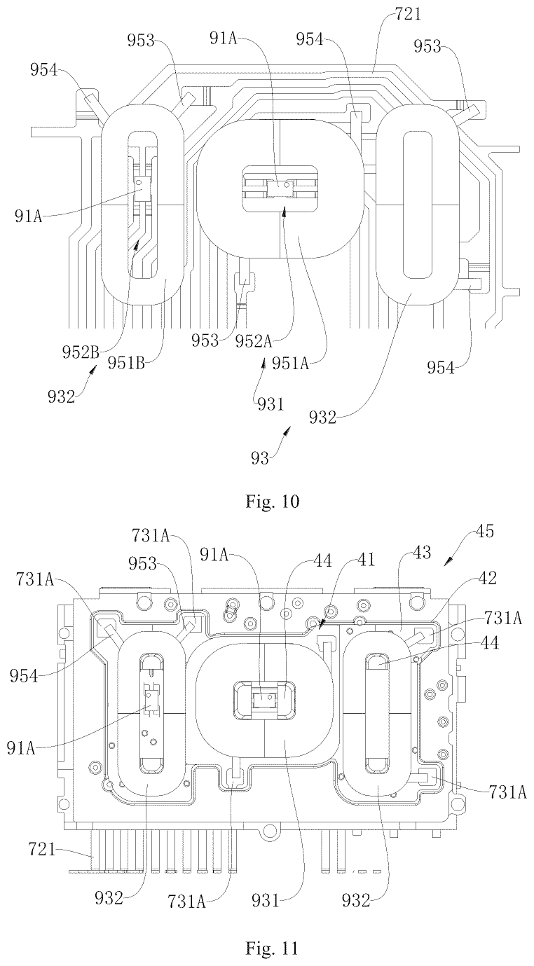

In some embodiments, as shown in FIGS. 10 and 11, the positive lead end 953 and the negative lead end 954 of each coil do not coincide with the coil body 951 of each coil in the direction perpendicular to the bottom plate 43. That is, in a case where the connecting end 731 of the conductive member 70 does not overlap with the coil main body 951 of each coil, and the positive lead end 953 and the negative lead end 954 are welded to the fixing end 73 of the conductive member 70, it is possible to prevent the coil main body 951 from interfering with the welding operation, which is beneficial to reduce the difficulty of the welding operation, and further beneficial to improve the efficiency of the welding operation. Also, it is beneficial to avoid unexpected conduction of the coil main body 951 of the coil and the connecting end 731 of the conductive member 70, reduce the risk of short circuit generation of the circuit, and improve the reliability of the circuit of the base.

Specifically, in some embodiments, further, the housing 1 has a separation structure 61 between the optical path turning portion 2 and the lens portion 3, for separating the optical path turning portion 2 and the lens portion 3, which is beneficial to avoid interference between the optical path turning portion 2 and the lens portion 3 during moving. Further, the housing 1 further has a positioning structure 62 adapted to position a fixing lens portion to mount the lens portion 3.

In a specific embodiment, as shown in FIGS. 10 to 13, the anti-shake magnet 101 is mounted on the side surface of the optical path turning portion 2 facing to the first side wall 21, and the anti-shake magnet 101 comprises one pitch magnet 102 and two swing magnets 103, and the swing magnets 103 are located on two sides of the pitch magnet 102 along the third axis A3. Further, the first side wall 21 has a first mounting portion 45, the anti-shake coil 93 is accommodated in the recess 41 of the first mounting portion 45, and the first portion 721 of the mounting branch 72 for connecting with the anti-shake coil 93 is embedded in the bottom plate 43 of the first mounting portion 45, that is, the first portion 721 for connecting with the anti-shake coil 93 is located in the first side wall 21, which is beneficial to make the distribution of the conductive member 70 in the housing 1 more uniform and the wiring more concise.

It can be understood that the anti-shake coil 93 comprises one pitch coil 931 and two swing coils 932. The pitch coil 931 has a first coil body 951A and a first mounting hole 952A defined by the first coil body 951A. The swing coil 932 has a second coil body 951B and a second mounting hole 952B defined by the second coil body 951B. The pitch coil 931 is located in the middle region of the recess 41 of the first mounting portion 45, so as to be facing to the pitch magnet 102 along the second optical axis OA2, and the pitch coil 931 is conducted with the first portion 721 of the connecting branch 71 through the first connecting end 731A to be energized, so that the optical path turning portion 2 is driven to pitch around the third axis A3 by the relative action of the pitch coil 931 and the pitch magnet 102. Further, the two swing coils 932 are located on two sides of the pitch coil 931 along the third axis A3, and are provided facing to the swing magnet 103 along the second optical axis OA2. The swing coils 932 is conducted with the first connecting end 731A through the first portion 721 of the connecting branch 71 to be energized, and the optical path turning portion 2 can be driven to swing around the first optical axis OA1 by the relative action of the swing coils 932 and the swing magnet 103.

As shown in FIGS. 10 and 11, in a case where one conductive member 70 has two connecting ends 731, the positive lead end 953 of one swing coil 932 and the negative lead end 954 of the other swing coil 932 are respectively connected through two first connecting ends 731A of one conductive member 70, and the negative lead end 954 of one swing coil 932 and the positive lead end 953 of the other swing coil 932 are respectively connected through two first connecting ends 731A of the other conductive member 70, so that the positive lead end 953 and the negative lead end 954 of two swing coils 932 are connected through two conductive members 70 with two connecting ends 731. It can be understood that the conductive member 70 further has a controlling end 732 conductively connected to the controlling portion 92, and the two controlling ends 732 of the two conductive members 70 can control the energization of the two swing coils 932 together, which is beneficial to simplify the wiring of the conductive member 70 and make the structure of the base more compact.

Further, the positive lead end 953 and the negative lead end 954 of the pitch coil 931 are respectively connected through the first connecting ends 731A of the two conductive members 70, thereby controlling the energization of the pitch coil 931. That is, the pitch coil 931 and the two swing coils 932 can be connected to the controlling portion 92 by the four conductive members 70, which is beneficial to reduce the number of conductive members 70, thereby reducing the wiring difficulty, and also making the structure of the base more compact.

It can be understood that the positive lead end 953 and the negative lead end 954 of one swing coil 932 and the positive lead end 953 and the negative lead end 954 of the other swing coil 932 can be respectively conductively connected through the first connecting end 731A of the four conductive members 70. That is, each of the swing coils 932 is connected to the controlling portion 92 by two conductive members 70, and the wiring of the conductive members 70 is simplified.

In another specific embodiment, the pitch magnet 102 is mounted on the side of the optical path turning portion 2 facing the first side wall 21, one swing magnet 103 is mounted on the side of the optical path turning portion 2 facing the second side wall 22, and the other swing magnet 103 is mounted on the side of the optical path turning portion 2 facing to the third side wall 23. Further, the first side wall 21 is provided with a first mounting portion 45, and the pitch coil 931 is accommodated in the recess 41 of the first mounting portion 45 to be facing the pitch magnet 102 along the second optical axis OA2. The pitch coil 931 is conducted and energized with the first portion 721 of the connecting branch 71 through the first connecting end 731A, and the optical path turning portion 2 is driven to pitch around the third axis A3 by the relative action of the pitch coil 931 and the pitch magnet 102. Further, the second side wall 22 and the third side wall 23 each have a fourth mounting portion for accommodating the swing coil 932, so that the swing coil 932 and the swing magnet 103 are facing each other along the third axis A3, and the swing coil 932 is conducted to the second portion 722 and the third portion 723 of the connecting branch 71 by the first connecting end 731A to be energized, so that the optical path turning portion 2 can be driven to swing around the first optical axis OA1 by the relative action of the swing coil 932 and the swing magnet 103.

In some embodiments, as shown in FIGS. 14 to 16, the lens portion 3 is driven by one side, and the focus coil 94 has a third coil body 951C and a third mounting hole 952C defined by the third coil body 951C. Specifically, the focus magnet 301 is mounted on the side surface of the lens portion 3 facing the second side wall 22, and the second side wall 22 of the housing 1 is provided with a second mounting portion 46, the second mounting portion 46 and the lens portion 3 facing each other along the third axis A3. The focus coil 94 is accommodated in the recess 41 of the second mounting portion 46, and is disposed facing to the focus magnet 301 along the third axis A3. The focus coil 94 is conducted to the second portion 722 of the connecting branch 71 by the second connecting end 731B to be energized, and the lens portion 3 is driven to move along the second optical axis OA2 by the relative action of the focus coil 94 and the focus magnet 301.

In other embodiments, the lens portion 3 is driven by two sides. Specifically, the lens portion 3 comprises two focus magnets 301, one of the focus magnets 301 is mounted on a side surface of the lens portion 3 facing the second side wall 22, and the other focus magnet 301 is mounted on a side surface of the lens portion 3 facing the third side wall 23. In another embodiment, the second side wall 22 and the third side wall 23 of the housing 1 are provided with a second mounting portion 46 for accommodating the focus coil 94, so that the focus coil 94 is facing the focus magnet 301 along the third axis A3. The focus coil 94 located on the second side wall 22 is conducted to the second portion 722 of the connecting branch 71 through the second connecting end 731B to be energized, and the focus magnet 94 located on the third side wall 723 is conducted to the third portion 723 of the connecting branch 71 by the second connecting end 731B to be energized, and the lens portion 3 is driven to move along the second optical axis OA2 by the relative action of the focus coil 94 and the focus magnet 301.

It can be understood that the first portion 721 and the first connecting end 731A located on the first side wall 21, the second portion 722, the second connecting end 731B and the third connecting end 731C located on the second side wall 22, and the third portion 723, the second connecting end 731B and the third connecting end 731C located on the third side wall 23 are all connected through the connecting branch 71 located on the bottom wall 10 and the third portion 723 and the controlling end 732 located on the third side wall 23, so that the wiring distribution of the conductive member 70 on the base is more uniform, and it is beneficial to avoid the wiring concentration of a certain part from affecting the structural strength of the base.

Further, in some embodiments, as shown in FIGS. 10 and 11, the first sensing component 91A is located in the anti-shake coil 93 and is disposed facing to the anti-shake magnet 101 along the second optical axis OA2, that is, along the second optical axis OA2, the projections of the first sensing component 91A and the anti-shake magnet 101 are overlapped, so that the position of the optical path turning portion 2 can be detected by sensing the position change of the anti-shake magnet 101. Specifically, the first sensing component 91A is located in the first mounting hole 952A of the pitch coil 931 so as to be disposed facing to the pitch magnet 102, and/or in the second mounting hole 952B of the swing coil 932 so as to be disposed facing the swing magnet 103.

Similarly, the second sensing component 91B is located in the third mounting hole 952C of the focus coil 94, and is disposed facing to the focus magnet 301 along the third axis A3, that is, along the third axis A3, the projections of the second sensing component 91B and the focus magnet 301 are overlapped, so that the position of the lens portion 3 can be detected by sensing the position change of the focus magnet 301.

It can be understood that the sensing component 91 is disposed in the mounting hole 952, so that the arrangement of the electronic assembly 90 on the base is more compact, which is beneficial to saving space. In addition, the connecting end 731 for connecting and conducting with the sensing component 91 can also be located in the mounting hole 952, which facilitates more concentration of the wiring of the conductive member 70.

In another embodiment, as shown in FIG. 14, the second sensing component 91B is located outside the focus coil 94 and is located on the second side wall 22 together with the focus coil 94. In a case where the projections of the second sensing component 91B and the focus magnet 301 are overlapped along the third axis A3, the second sensing component 91B can detect the position of the lens portion 3 by sensing the position change of the focus magnet 301. On the contrary, in a case where the projections of the second sensing component 91B and the focus magnet 301 are not overlapped along the third axis A3, it is necessary to attach a sensing magnet to the lens portion 3, and the sensing magnet and the second sensing component 91B are disposed facing each other along the third axis A3, so that the second sensing component 91B can detect the position of the lens portion 3 by sensing the position change of the sensing magnet.

Similarly, the first sensing component 91A is located outside the anti-shake coil 93 and is located on the first side wall 21 together with the anti-shake coil 93. In a case where the projections of the first sensing component 91A and the anti-shake magnet 101 are overlapped along the second optical axis OA2, the first sensing component 91A can detect the position of the optical path turning portion 2 by sensing the position change of the anti-shake magnet 101. On the contrary, in a case where the projections of the first sensing component 91A and the anti-shake magnet 101 are not overlapped along the second optical axis OA2, it is necessary to attach the sensing magnet to the optical path turning portion 2, and the sensing magnet and the first sensing component 91A are disposed facing each other along the second optical axis OA2, so that the first sensing component 91A can detect the position of the optical path turning portion 2 by sensing the position change of the sensing magnet.

It can be understood that providing the sensing component 91 on the outside of the coil body 951 is beneficial to reduce the magnetic interference phenomenon of the coil to the sensing component 91, which makes the monitoring result of the sensing component 91 more accurate, and improves the accuracy of the position control of the optical path turning portion 2 and the lens portion 3.

In other embodiments, the anti-shake coil 93 is disposed on the first side wall 21, the first sensing component 91A is disposed on the second side wall 22 and/or the third side wall 23. Further, a sensing magnet is mounted on the side surface of the optical path turning portion 2 facing the second side wall 22 and/or the third side wall 23, and the sensing magnet and the first sensing component 91A are disposed facing each other along the third axis A3, so that the first sensing component 91A can detect the position of the optical path turning portion 2 by sensing the position change of the sensing magnet. It can be understood that the first sensing component 91A is disposed on the outside of the anti-shake coil 93 and on the different sides wall 20 with the anti-shake coil 93, which is beneficial to reduce the magnetic interference phenomenon of the anti-shake coil 93 on the first sensing component 91A, makes the monitoring result of the first sensing component 91A more accurate, and improves the accuracy of the position control of the optical path turning portion 2.

It is worth mentioning that along the direction perpendicular to the bottom plate 43, the projections of the each sensing components 91 and the connecting ends 731 for connecting the sensing components 91 are overlapped, so that the sensing components 91 can be attached and welded to the connecting ends 731, which is beneficial to reduce the difficulty of the welding operation and improve the efficiency of the welding operation.

It is understood that the sensing component 91 can be a Hall Sensor, a Magnetoresistance Effect Sensor (MR Sensor), a Giant Magnetoresistance Effect Sensor (GMR Sensor), a Tunneling Magnetoresistance Effect Sensor (TMR Sensor), or a Fluxgate Sensor, which is not specifically limited in the present disclosure.

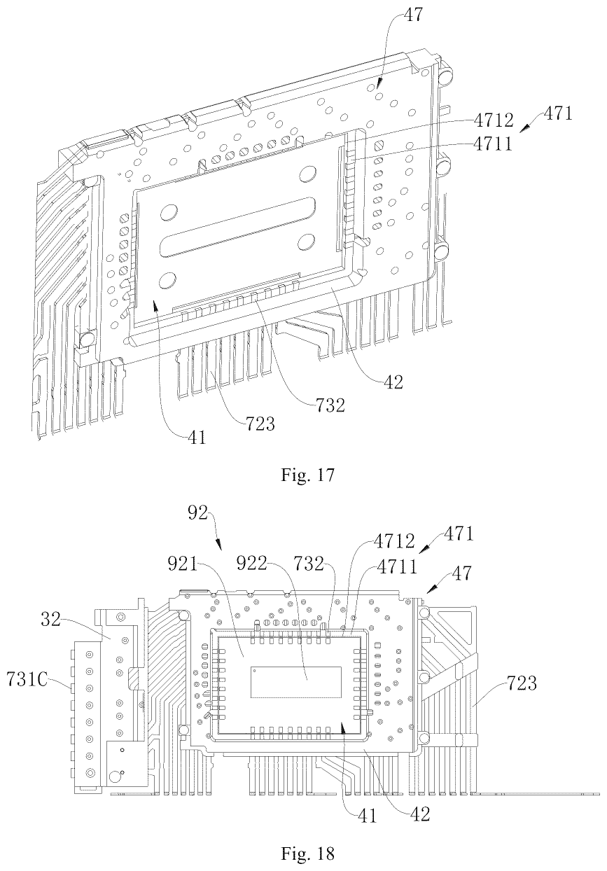

As shown in FIGS. 17 and 18, the controlling portion 92 comprises a substrate 921 and an integrated circuit 922 mounted on the substrate 921, and the peripheral side of the substrate 921 has a plurality of pads to conductively connect the controlling end 732 of the conductive member 70. The third side wall 23 of the housing 1 is provided with a third mounting portion 47, for accommodating the substrate 921 and the integrated circuit 922 of the controlling portion 92. Specifically, the peripheral side of the surface of the bottom plate 43 of the third mounting portion 47 is convexly provided with a protruding boss portion 471 having an upper table surface 4711 parallel to the surface of the bottom plate 43 and a side boss surface 4712 perpendicular to the surface of the bottom plate 43. An avoidance space is formed between the side boss surfaces 4712 for placing the substrate 921. The controlling ends 732 of each conductive member 70 are distributed on the protruding boss portion 471, and the controlling ends 732 are exposed on the upper boss surface 4711 of the protruding boss portion 471, so as to be conductively connected to the pads on the substrate 921.

Optionally, in a case where the substrate 921 is placed in the avoidance space, the upper surface of the substrate 921 is coplanar with the upper boss surface 4711 of the protruding boss portion 471, so that the pads and the controlling end 732 are located in the same plane, which is beneficial to reduce the difficulty of welding, thereby facilitating welding and conducting the pad and the controlling end 732, and making the structure of the base more compact.

Further, since the end surface of the controlling end 732 is exposed on the side boss surface 4712 of the protruding boss portion 471, the wieldable area of the controlling end 732 is increased, the welding strength between the controlling end 732 and the pad is improved, and the reliability of the conductive connection between the conductive member 70 and the substrate 921 is improved.

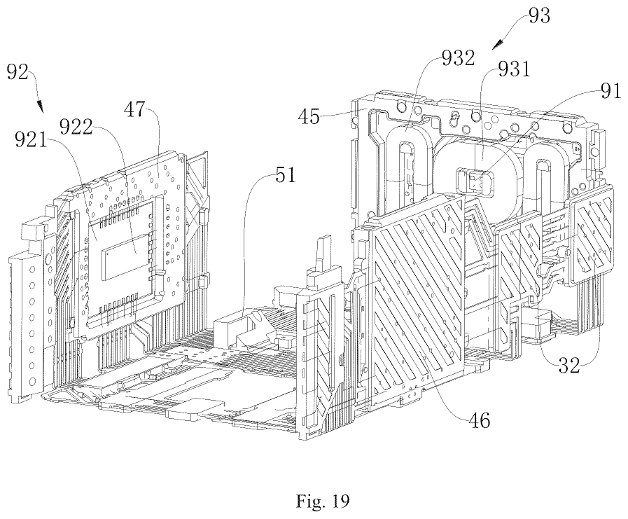

In some embodiments, as shown in FIG. 19, the housing 1 further comprises a heightening portion 51 extended from the fixing portion 30 and/or the mounting portion 40 toward an intermediate area of the base to provide positioning for subsequent processes.

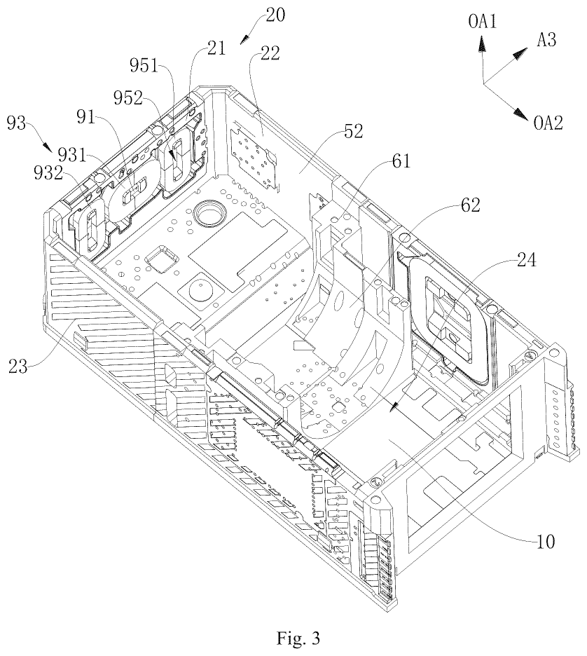

Further, as shown in FIGS. 2 and 3, the housing 1 further comprises a molding portion 52 covering the connecting branch 71, the mounting branch 72, at least part of the fixing portion 30, at least part of the mounting portion 40, and at least part of the heightening portion 51, thereby forming the bottom wall 10 and the side wall 20. That is, the molding portion 52 is capable of integrally connecting the connecting branch 71, the mounting branch 72, the fixing portion 30, the mounting portion 40, and the heightening portion 51, which are dispersedly disposed, to form the bottom wall 10 and the side wall 20 of the housing 1, and to form the separation structure 61 between the optical path turning portion 2 and the lens portion 3, and the positioning structure 62 of the lens portion 3.

Specifically, the molding portion 52 can be injection molded in a plurality of times. For example, the bottom wall 10 and the side wall 20 surrounding the peripheral side of the optical path turning portion 2, and the bottom wall 10 and the side wall 20 surrounding the peripheral side of the lens portion 3 can be injection molded in two times. The molding portion 52 can be integrally molded by one-time injection molding. The present disclosure does not specifically limit.

It is worth mentioning that, for a structure having a relatively large wall thickness in the housing 1, such as the separation structure 61 between the optical path turning portion 2 and the lens portion 3 and the positioning structure 62 of the lens portion 3, as compared with one-time injection molding by the molding portion 52, it is preferable that a part of the structure is formed by the heightening portion 51 firstly, and then completely formed by the molding portion 52 covering the heightening portion 51, which is beneficial to reduce the shrinkage rate of the housing 1 and reduce the risk of other defects.

A manufacturing method for the base of the periscopic camera module, comprises the steps of:
a, providing a first material strip for forming a conductive member 70, where the conductive member 70 comprises a connecting branch 71 and a mounting branch 72 formed on at least three peripheral sides of the connecting branch 71, to form a first portion 721, a second portion 722 and a third portion 723 of the mounting branch 72 respectively, to obtain a first semi-finished product;
b, firstly injection molding of the first semi-finished product, to form the mounting portion 40, to obtain a second semi-finished product;
c, providing the electronic assembly 90, to mount the electronic assembly 90 on the mounting portion 40 of the second semi-finished product and weld the electronic assembly 90 with the controlling end 732 or the connecting end 731 of the conductive member 70. to obtain the third semi-finished product;
d, bending the conductive member 70 of the third semi-finished product, to form the connecting branch 71 located on the bottom wall 10 and the mounting branch 72 located on the side wall 20, to obtain the fourth semi-finished product; and
e, secondly injection molding the fourth semi-finished product, to connect the first mounting portion 45, the second mounting portion 46 and the third mounting portion 47 separated from each other, to cover the rest of the conductive member 70, to form the molding portion 52, to obtain the base of the periscopic camera module.

Specifically, in Step a, the mounting branch 72 comprises a first portion 721 fixed to the anti-shake coil 93 of the electronic assembly 90 and a second portion 722 fixed to the focus coil 94 of the electronic assembly 90. The first portion 721 is embedded in the first side wall 21 of the side wall 20 and the second portion 722 is embedded in the second side wall 22 and/or the third side wall 23 of the side wall 20.

In Step b, a first mounting portion 45, a second mounting portion 46, and a third mounting portion 47, which partially cover the first portion 721, the second portion 722, and the third portion 723, respectively, are formed to obtain a second semi-finished product.

It is worth mentioning that Step a further comprises providing a second material strip for forming the reinforcing member 80, to position the first material strip and the second material strip, so that the conductive member 70 and the reinforcing member 80 are provided at intervals, to obtain the first semi-finished product. Step b further comprises forming a fixing portion 30 fixing the reinforcing member 80 and the conductive member 70, so that the reinforcing member 80 and the conductive member 70 are provided at intervals, to obtain the second semi-finished product. Further, the fixing portion 30 and the mounting portion 40 can be injection molded in one-time, or can be injection molded in two times to mold the fixing portion 30 and the mounting portion 40 respectively.

The electronic assembly 90 in Step c comprises an anti-shake coil 93 mounted on the first portion 721, a focus coil 94 mounted on at least one of the second mounting portion 46 and the third mounting portion 47, and a controlling portion 92 mounted on one of the second mounting portion 46 and the third mounting portion 47.

Step c specifically comprises: c1, mounting the pitch coil 931 and the swing coil 932 on the protruding post 44 in the recess 41 of the first mounting portion 45, and connecting and conducting with the first connecting end 731A; c2, mounting the focus coil 94 on the protruding post 44 in the recess 41 of the second mounting portion 46, and connecting and conducting with the second connecting end 731B; c3, mounting the sensing component 91 in the recess 41 of the first mounting portion 45 and the second mounting portion 46, and connecting and conducting with the connecting end 731; and c4, mounting the substrate 921 in the avoidance space of the recess 41 of the third mounting portion 47, connecting and conducting with the controlling end 732 of the protruding boss portion 471, and mounting the integrated circuit 922 on the substrate 921. It is to be understood that the sequential execution of the respective steps in Step c is not particularly limited, and can be performed simultaneously.

In Step d, the conductive member 70 of the third semi-finished product is bent, so that the mounting branch 72 is bent in a vertical arrangement with respect to the connecting branch 71, where the first mounting portion 45, the second mounting portion 46, and the third mounting portion 47 are bent with respect to the connecting branch 71 without interfering with each other, to obtain the fourth semi-finished product. It can be understood that the first mounting portion 45 covers the first portion 721 of the mounting branch 72, the second mounting portion 46 covers the second portion 722, and the third mounting portion 47 covers the third portion 723, so that each portion of the mounting branch 72 is relatively independent and does not interfere with each other during bending, and it is only necessary to bend each portion of the mounting branch 72 to change from the horizontal state to the vertical state, the bending process is relatively simple, and problems such as deformation and dislocation are not easy to occur, which is beneficial to improving the yield. The each portion of the mounting branch 72 after bending is independent of each other in the vertical direction.

In Step e, the molding portion 52 can be injection molded in a plurality of times. For example, by injection molding in two times, respectively molding a part of the bottom wall 10, the first side wall 21, a part of the second side wall 22, and a part of the third side wall 23 surrounding the peripheral side of the optical path turning portion 2, and molding the other part of the bottom wall 10, the other part of the second side wall 22, and the other part of the third side wall 23 surrounding the peripheral side of the lens portion 3. The molding portion 52 can be integrally molded by one-time injection molding.

As shown in FIG. 1, a periscopic camera module comprises the base of the periscopic camera module described above, the optical path turning portion 2, and the lens portion 3. The optical path turning portion 2 is accommodated in the base of the periscopic camera module, and is adapted to pitch about the third axis A3 and swing about the first optical axis OA1. The lens portion 3 is accommodated in the base of the periscopic camera module and is adapted to move along the second optical axis OA2 and/or in a plane perpendicular to the second optical axis OA2.

That is, the base defines the accommodation space 24, the optical path turning portion 2 is mounted in the accommodation space 24, the optical path turning portion 2 and the anti-shake coil 93 facing each other along the second optical axis OA 2, and the optical path turning portion 2 is driven to perform the anti-shake motion. The lens portion 3 is further mounted in the accommodation space 24, and the lens portion 3 and the focus coil 94 are facing each other along perpendicular to the third axis A3, the lens portion 3 is driven to perform focus motion.

It can be understood that the conductive member 70 and the reinforcing member 80 are embedded in the housing 1 of the base, which can enhance the structural reliability of the base on the basis of simplifying the circuit design, and can avoid independently placing the circuit board in the base, which is beneficial to make the structure of the periscopic camera module more compact, and further reduce the size of the periscopic camera module, which is beneficial to realize the miniaturization of the periscopic camera module. It can be understood that, since the conductive member 70 is protected by the housing 1, the risk of the conductive member 70 being damaged is reduced when the periscopic camera module receives an external force, which is beneficial to improve the reliability of the circuit of the periscopic camera module.

Further, the periscopic camera module further comprises a photosensitive assembly mounted on the base of the periscopic camera module and conductively connected to the controlling portion 92 through the connecting end 731 of the mounting branch 72 exposed on the base. Specifically, the photosensitive module is conductively connected to the controlling portion 92 through the third connecting end 731C of the mounting branch 72.

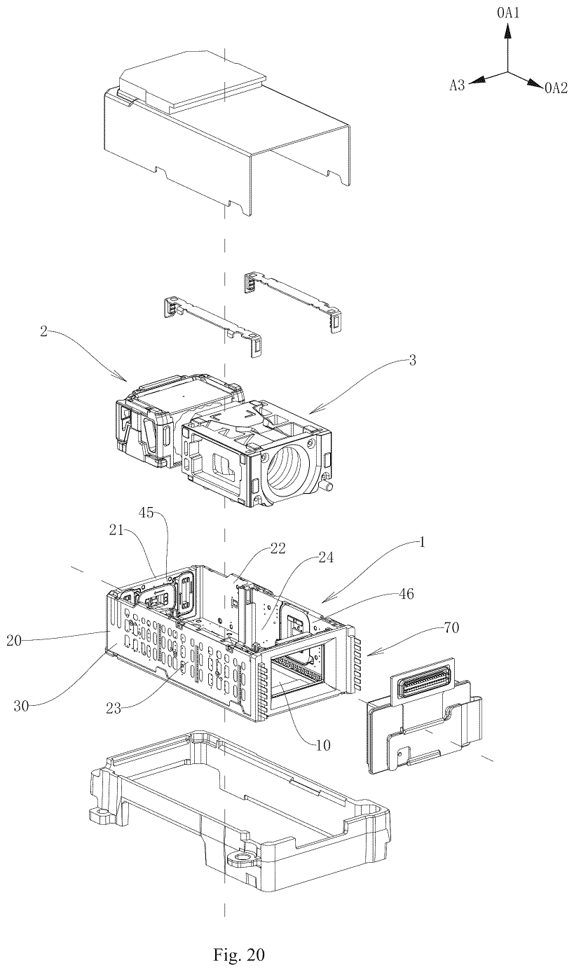

Referring to FIGS. 20 to 23 of the drawings of the specification of the disclosure, a base of a periscopic camera module according to another some embodiments of the disclosure is illustrated, which comprises a housing 1 comprising a bottom wall 10 and a plurality of side walls 20 located on the peripheral side of the bottom wall 10. An accommodation space 24 is formed between the bottom wall 10 and the side walls 20 for accommodating an optical path turning portion 2 and a lens portion 3 of the periscopic camera module. The base further comprises a plurality of conductive members 70 embedded in the bottom wall 10 and the side wall 20. The conductive member 70 comprises a first group of conductive members 74 and a second group of conductive members 75 embedded in the housing 1, where the first group of conductive members 74 and the second group of conductive members 75 can be directly connected to the circuit board of the photosensitive assembly of the periscopic camera module respectively, so that the periscopic camera module and the external circuit are conducted through the circuit board. The first group of conductive members 74 can be used to conduct the anti-shake coil 93 and the circuit board, and the second group of conductive members 75 can be used to conduct the focus coil 94, the drive integrated component 96, and the circuit board. The first group of conductive members 74 is embedded in the bottom wall 10 and the side wall 20, and the second group of conductive members 75 is all embedded in the side wall 20. Since the second group of conductive members 75 no longer need to extend and embed in the bottom wall 10 to span the opposite side wall 20, the part of the conductive members 70 embedded in the bottom wall 10 is reduced, and the circuit complexity is reduced.

It can be understood that the conductive member 70 is covered in the bottom wall 10 and the side wall 20 of the housing 1, so that the positioning function and the protection function of the conductive member 70 can be realized by the housing 1, which is beneficial to reduce the risk of damage of the conductive member 70 when impacted by an external force, and thus can improve the reliability of the circuit of the periscopic camera module.

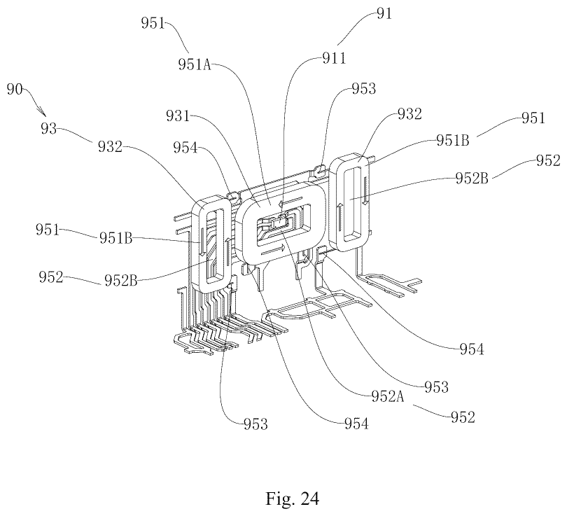

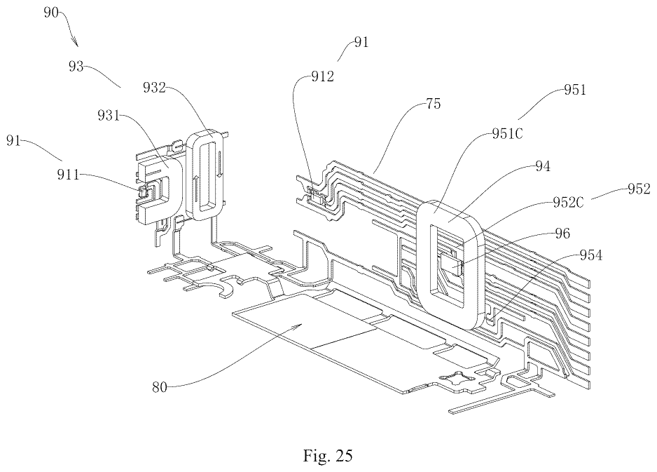

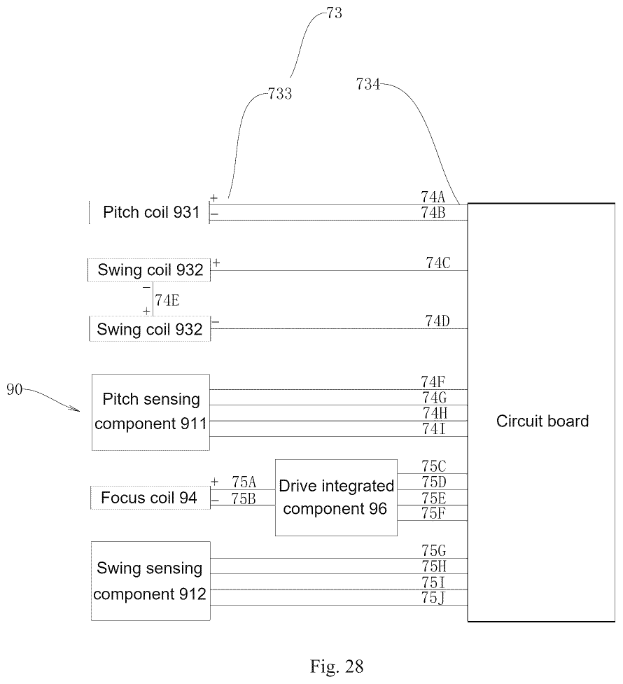

As shown in FIGS. 20 to 28, the conductive member 70 comprises two fixing ends 73 conductively connected to the electronic component in the circuit board or the electronic assembly 90. The two fixing ends 73 of a part of the conductive members 70 are two electronic component fixing ends 733, and the two fixing ends 73 of the other part of the conductive members 70 are respectively the electronic component fixing ends 733 and circuit board fixing ends 734. The conductive member 70 is conductively connected to the electronic component through the electronic component fixing ends 733 and the conductive member 70 is conductively connected to the circuit board through the circuit board fixing ends 734. The electronic assembly 90 comprises electronic components, such as a sensing component 91, an anti-shake coil 93, a focus coil 94, and a drive integrated component 96. The anti-shake coil 93 comprises one pitch coil 931 and two swing coils 932, the sensing component 91 comprises a pitch sensing component 911 and a swing sensing component 912, and the drive integrated component 96 integrates a drive IC and a focus sensing component. Optionally, the fixing ends 73 are each provided on the side wall 20.

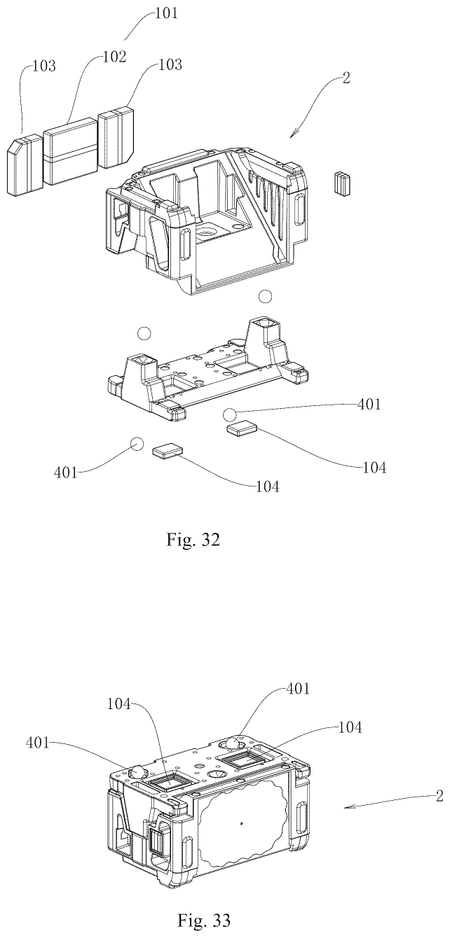

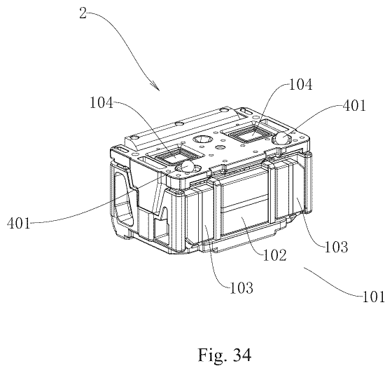

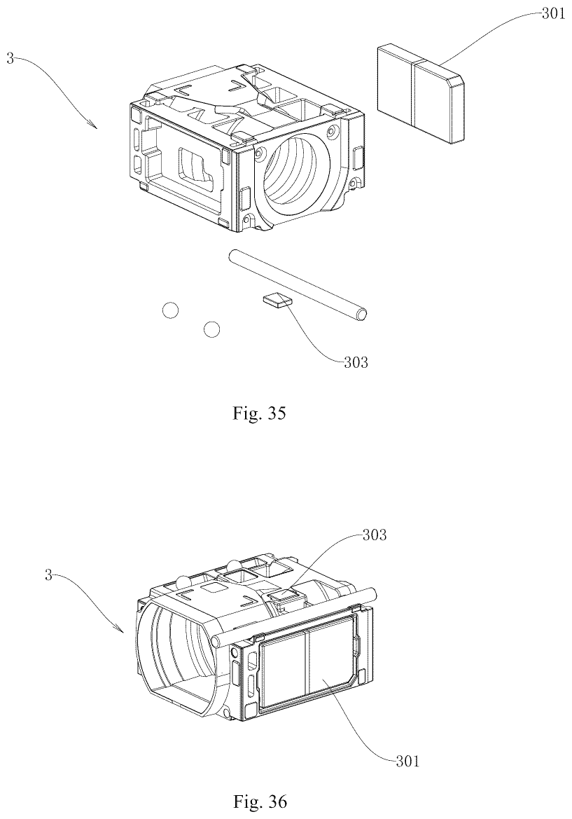

As shown in FIGS. 20 to 23 and 32 to 36, the anti-shake coil 93 interacts with the anti-shake magnet 101 mounted on the optical path turning portion 2, to drive the optical path turning portion 2 to swing about the first optical axis OA1 or to pitch about the third axis A3. The focus coil 94 interacts with a focus magnet 301 mounted on the lens portion 3, to drive the lens portion 3 to move along the second optical axis OA2. The pitch sensing component 911 and the swing sensing component 912 detect the position of the optical path turning portion 2, specifically, the pitch position and the swing position of the optical path turning portion 2 respectively. The focus sensing component of the drive integrated component 96 detects the position of the lens portion 3. The external circuit comprises an electronic component such as a photosensitive assembly located outside the accommodation space 24 of the housing 1. It is worth mentioning that the first optical axis OA1 refers to the center line of the light on the periscopic camera module, the second optical axis OA2 refers to the center line of the light emitted from the periscopic camera module, and the third axis A3 is orthogonal to the first optical axis OA1 and the second optical axis OA2.

As shown in FIGS. 20 to 22, the housing 1 has a substantially rectangular bottom wall 10 and side walls 20 located on a peripheral side of the bottom wall 10. The side walls 20 comprise a first side wall 21, a second side wall 22 and a third side wall 23, the second side wall 22 and the third side wall 23 are facing each other on two sides of the bottom wall 10 along the third axis A3, and the first side wall 21 is perpendicular to the second optical axis OA2 and located between the second side wall 22 and the third side wall 23. The accommodation space 24 is formed between the first side wall 21, the second side wall 22, the third side wall 23, and the bottom wall 10, for accommodating the optical path turning portion 2 and the lens portion 3. The lens portion 3 is provided between the second side wall 22 and the third side wall 23, and is adapted to move along the second optical axis OA2. The optical path turning portion 2 is located between the lens portion 3 and the first side wall 21, and is adapted to pitch about the third axis A3 and swing about the first optical axis OA1.

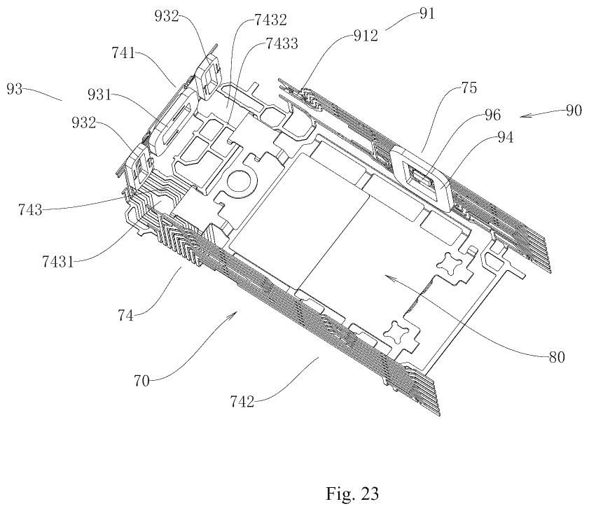

As shown in FIGS. 23 to 28, the first group of conductive members 74 is embedded in the first side wall 21, the bottom wall 10, and the third side wall 23. The fixing ends 73 of the first group of conductive members 74 comprise an electronic component fixing end 733 conductively connected to the anti-shake coil 93. The circuit board fixing end 734 of the first group of conductive members 74 is conductively connected with the circuit board. The second group of conductive members 75 are all embedded in the second side wall 22, and do not interfere with the first group of conductive members 74, so that the wiring distribution of the circuit is more uniform, and the wiring concentration is avoided to affect reliability. The fixing end 73 of the second group of conductive members 75 comprises an electronic component fixing end 733 conductively connected to the focus coil 94 and the drive integrated component 96 respectively, and the circuit board fixing end 734 of the second group of conductive members 75 is conductively connected to the circuit board. All of the circuit board fixing ends 734 of the conductive member 70 are respectively exposed on the end of the second side wall 22 (the end away from the first side wall 21) and the end of the third side wall 23 (the end away from the first side wall 21). For example, the circuit board fixing ends 734 are integrally extended from the end of the second side wall 22 and the end of the third side wall 23, to conductively connect to the circuit board of the photosensitive module of the periscopic camera module.

Alternatively, the circuit board fixing end 734 can be integrally embedded in the second side wall 22 and the third side wall 23, and is connected to the circuit board only through the exposed surface, so that the circuit board fixing end 734 can be fixed and protected by the second side wall 22 and the third side wall 23 of the housing 1, which is beneficial to reduce the risk of deformation or even fracture of the circuit board fixing end 734.

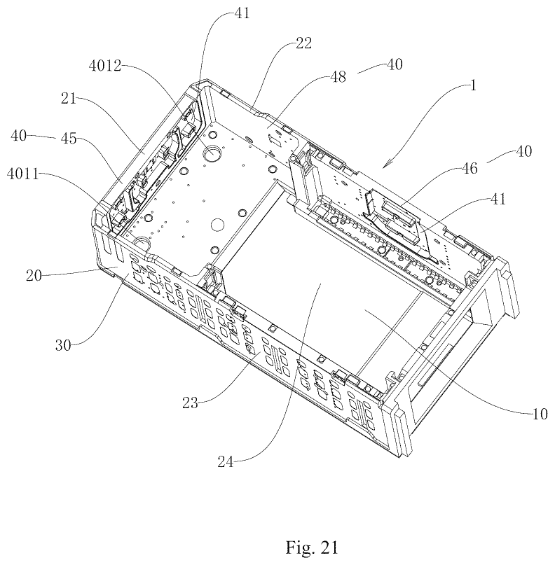

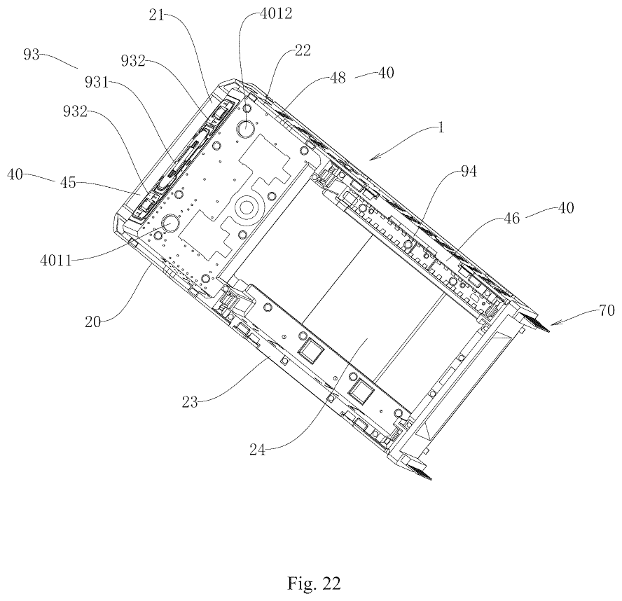

As shown in FIGS. 21 and 22, the anti-shake coil 93 driving the optical path turning portion 2 to move is located on the first side wall 21 of the housing 1, and is parallel to the first optical axis OA1 and perpendicular to the second optical axis OA2. The electronic component fixing ends 733 conductively connected to the anti-shake coils 93 among the fixing ends 73 of the first group of conductive members 74 are located on the first side wall 21 of the housing 1. The focus coil 94 driving the lens section 3 to move is located on the second side wall 22 of the housing 1. The electronic component fixing ends 733 conductively connected to the focus coil 94 among the fixing ends 73 of the second group of conductive members 75 are located on the second side wall 22 of the housing 1.

As shown in FIG. 23, the housing 1 further comprises a mounting portion 40 located on the side wall 20. The mounting portion 40 covers a part of the conductive member 70 close to the electronic component fixing end 733, and the middle region of the mounting portion 40 has a recess 41 for accommodating the electronic assembly 90. It can be understood that by forming the mounting portion 40 in advance by injection molding, the structure of the conductive members 70 (especially the relative positional relationship between the conductive members 70) can be preliminarily fixed and maintained, so as to avoid abnormal deformation and short circuit in the subsequent manufacturing process. The mounting portion 40 comprises a first mounting portion 45 located on the first side wall 21 and a second mounting portion 46 located on the second side wall 22. The anti-shake coil 93 is accommodated in the first mounting portion 45, and the focus coil 94 is accommodated in the second mounting portion 46.

As shown in FIGS. 23, 32 to 34, the pitch coil 931 is located in the middle region of the recess 41 of the first mounting portion 45, so as to face the pitch magnet 102 of the anti-shake magnet 101 along the second optical axis OA2. The two swing coils 932 are located on two sides of the pitch coil 931 correspondingly along the third axis A3, so as to face the two swing magnets 103 of the anti-shake magnet 101 along the second optical axis OA2. In other words, the anti-shake magnet 101 comprises one pitch magnet 102 and two swing magnets 103, mounted on the side surface of the optical path turning portion 2 facing the first side wall 21. The two swing magnets 103 are located on two sides of the pitch magnet 102 correspondingly along the third axis A3, so as to correspond to the pitch coil 931 and the swing coil 932 of the anti-shake coil 93 respectively.

As shown in FIGS. 23, 35, and 36, the focus coil 94 is accommodated in the recess 41 of the second mounting portion 46, and the second mounting portion 46 and the lens portion 3 are disposed facing to each other along the third axis A3, so that the focus coil 94 and the focus magnet 301 are disposed facing to each other along the third axis A3. In other words, the focus magnet 301 is mounted on the side of the lens portion 3 facing the second side wall 22, so as to correspond to the focus coil 94.

Specifically, the anti-shake coil 93 and the focus coil 94 each have a coil body 951, a positive lead end 953, a negative lead end 954 formed from the coil body 951. An inner wall of the coil body 951 defines a mounting hole 952. The pitch coil 931 has a first coil body 951A and a first mounting hole 952A defined by the first coil body 951A, the swing coil 932 has a second coil body 951B and a second mounting hole 952B defined by the second coil body 951B, and the focus coil 94 has a third coil body 951C and a third mounting hole 952C defined by the third coil body 951C.

As shown in FIGS. 23 to 28, the first group of conductive members 74 comprises the following conductive members:
a first conductive member 74A, having one circuit board fixing end 734, and one electronic component fixing end 733 conductively connected to the positive lead end 953 of the pitch coil 931;
a second conductive member 74B, having one circuit board fixing end 734, and one electronic component fixing end 733 conductively connected to the negative lead end 954 of the pitch coil 931;
a third conductive member 74C, having one circuit board fixing end 734, and one electronic component fixing end 733 conductively connected to the positive lead end 953 of one swing coil 932;
a fourth conductive member 74D, having one circuit board fixing end 734, and one electronic component fixing end 733 conductively connected to the negative lead end 954 of the other swing coil 932; and
a series conductive member 74E, having two electronic component fixing ends 733 conductively connected to the negative lead end 954 of one swing coil 932 and the positive lead end 953 of the other swing coil 932 respectively.

It can be understood that the pitch coil 931 is energized by the first conductive member 74A and the second conductive member 74B, thus the optical path turning portion 2 is driven to pitch around the third axis A3 by the relative action of the pitch coil 931 and the pitch magnet 102. It is further understood that the two swing coils 932 are energized by the third conductive member 74C, the fourth conductive member 74D, and the series conductive member 74E, and are connected in series with each other, so that the optical path turning portion 2 can be driven to swing around the first optical axis OA1 by the relative action of the swing coil 932 and the swing magnet 103.

Specifically, four electronic component fixing ends 733 (the electronic component fixing end 733 of the third conductive member 74C, the electronic component fixing end 733 of the fourth conductive member 74D, and the two electronic component fixing ends 733 of the series conductive member 74E) conductively connected to the two positive lead ends 953 and the two negative lead ends 954 of the two swing coils 932 are respectively located outside and arranged close to the four corners of the pitch coil 931. Two electronic component fixing ends 733 (the electronic component fixing end 733 of the first conductive member 74A and the electronic component fixing end 733 of the second conductive member 74B) conductively connected to the positive lead end 953 and the negative lead end 954 of the pitch coil 931 are located below the pitch coil 931. With this arrangement, these electronic component fixing ends 733 are concentrated and distributed in the middle area of the area where the anti-shake coil 93 is located, so that these electronic component fixing ends 733 are conveniently exposed after injection molding of the first mounting portion 45, to be conveniently connected to the positive lead end 953 and the negative lead end 954 of the anti-shake coil 93 respectively. More specifically, in the first side wall 21, the series conductive member 74E is located on the upper side of the remaining conductive members, occupies a small space, and does not interfere with the arrangement space of the conductive member below the pitch coil 931. The design of the circuit is more reasonable, and the space utilization rate is improved.

As shown in FIGS. 23, 25, 35, and 36, the drive integrated component 96 is provided in the third mounting hole 952C of the focus coil 94, and is provided facing to the focus magnet 301 along the third axis A3, that is, in the direction along the third axis A3, the projections of the drive integrated component 96 and the focus magnet 301 are overlapped, so that the position change of the focus magnet 301 can be detected by the focus sensing component of the drive integrated component 96 to detect the position of the lens portion 3.

As shown in FIGS. 23 to 28, the second group of conductive members 75 comprise the following conductive members:
a fifth conductive member 75A, having two electronic component fixing ends 733 conductively connected to the positive lead end 953 of the focus coil 94 and a first pin 961 of the drive integrated component 96 respectively;
a sixth conductive member 75B, having two electronic component fixing ends 733 conductively connected to the negative lead end 954 of the focus coil 94 and a first pin 962 of the drive integrated component 96 respectively;
a seventh conductive member 75C, having one circuit board fixing end 734, and one electronic component fixing end 733 conductively connected to a third pin 963 of the drive integrated component 96;
an eighth conductive member 75D, having one circuit board fixing end 734, and one electronic component fixing end 733 conductively connected to a fourth pin 964 of the drive integrated component 96;
a ninth conductive member 75E, having one circuit board fixing end 734, and one electronic component fixing end 733 conductively connected to a fifth pin 965 of the drive integrated component 96; and
a tenth conductive member 75F, having one circuit board fixing end 734, and one electronic component fixing end 733 conductively connected to a sixth pin 966 of the drive integrated component 96.

It can be understood that the focus coil 94 is conductively connected to the drive integrated component 96 through the fifth conductive member 75A and the sixth conductive member 75B, and the drive integrated component 96 is conductively connected to the circuit board through the seventh conductive member 75C, the eighth conductive member 75D, the ninth conductive member 75E and the tenth conductive member 75F, thereby realizing the conductive connection of the focus coil 94, the drive integrated component 96 and the circuit board, so that the focus coil 94 is energized, and the lens portion 3 is driven to move along the second optical axis OA2 by the relative action of the focus coil 94 and the focus magnet 301.

It is worth mentioning that the first pin 961 and the second pin 962 of the drive integrated component 96 are located on the side of the drive integrated component 96 away from the circuit board, so that the distance between the circuit board and the other four pins (the third pin 963, the fourth pin 964, the fifth pin 965 and the sixth pin 966) connected to the circuit board is closer, which is beneficial to simplifying the circuit, making the design of the circuit more reasonable, and thus beneficial to increasing the reliability.

As shown in FIGS. 21 to 23, the pitch sensing component 911 is located in the anti-shake coil 93 and is disposed facing to the anti-shake magnet 101 along the second optical axis OA2, that is, along the second optical axis OA2, the projections of the pitch sensing component 911 and the anti-shake magnet 101 are overlapped, so that the position of the optical path turning portion 2 can be detected by sensing the position change of the anti-shake magnet 101. Specifically, the pitch sensing component 911 is located in the first mounting hole 952A of the pitch coil 931, facing to the pitch magnet 102, that is, the projections of the pitch sensing component 911 and the pitch magnet 102 are overlapped along the second optical axis OA2, and the position of the optical path turning portion 2 can be detected by sensing the position change of the pitch magnet 102.

Accordingly, in order to directly conductively connect the pitch sensing component 911 to the circuit board through the conductive members 70, the pitch sensing component 911 is conductively connected to the circuit board through the first group of conductive members 74 of the conductive members 70. Accordingly, the fixing ends 73 of the first group of conductive members 74 further comprise an electronic component fixing end 733 conductively connected to the pitch sensing component 911. Specifically, the first group of conductive members 74 further comprises an eleventh conductive member 74F, a twelfth conductive member 74G, a thirteenth conductive member 74H, and a fourteenth conductive member 74I. The eleventh conductive member 74F, the twelfth conductive member 74G, the thirteenth conductive member 74H, and the fourteenth conductive member 74I each have one circuit board fixing end 734 and one electronic component fixing end 733 conductively connected to the pitch sensing component 911, so as to conductively connect the four pins of the pitch sensing component 911 to the circuit board respectively, and realize the pitch position sensing function.

As shown in FIGS. 22 and 23, the mounting portion 40 further comprises a sensing component mounting portion 48. The sensing component mounting portion 48 is located on the second side wall 22, and the swing sensing component 912 is accommodated in the sensing component mounting portion 48. The sensing component mounting portion 48 and the sensing magnet of the optical path turning portion 2 are disposed facing to each other along the third axis A3, so that the swing sensing component 912 and the optical path turning portion 2 are facing each other along the third axis A3, and the swing position change of the optical path turning portion 2 can be detected by sensing the position change of the sensing magnet of the optical path turning portion 2.

Accordingly, in order to directly conductively connect the swing sensing component 912 to the circuit board through the conductive members 70, the swing sensing component 912 is conductively connected to the circuit board through the second group of conductive members 75 of the conductive members 70. Accordingly, the fixing ends 73 of the second group of conductive members 75 further comprises an electronic component fixing end 733 conductively connected to the swing sensing component 912. Specifically, the second group of conductive members 75 further comprises a fifteenth conductive member 75G, a sixteenth conductive member 75H, a seventeenth conductive member 75I, and an eighteenth conductive member 75J. The fifteenth conductive member 75G, the sixteenth conductive member 75H, the seventeenth conductive member 75I, and the eighteenth conductive member 75J each have one circuit board fixing end 734 and one electronic component fixing end 733 conductively connected to the swing sensing component 912, so as to conductively connect the four pins of the swing sensing component 912 to the circuit board respectively, and further realize the swing position sensing function.

It is worth mentioning that, in other embodiments of the disclosure, the swing sensing component 912 can be disposed in the second mounting hole 952B of the swing coil 932 or in the vicinity of the outside of the swing coil 932, so as to be disposed facing to the swing magnet 103. Of course, the swing sensing component 912 can be provided below the optical path turning portion 2, and can be provided facing to the sensing magnet of the optical path turning portion 2 along the first optical axis OA1. In addition, the swing sensing component 912 can be provided on the third side wall 23, and the optical path turning portion 2 needs to be separately disposed with a corresponding sensing magnet. In the embodiment in which the swing sensing component 912 is not provided on the second side wall 22, it is necessary to arrange matching conductive members to realize the conductive connection between the swing sensing component 912 and the circuit board, which is different from the fifteenth conductive member 75G, sixteenth conductive member 75H, seventeenth conductive member 75I and eighteenth conductive member 75J described above, and the circuit design is complicated, and the circuit wiring is uneven (the distribution of conductive members is uneven), which easily affects the overall reliability. In other words, by providing the swing sensing component 912 on the sensing component mounting portion 48 of the second side wall 22, the conductive connection between the swing sensing component 912 and the circuit board can be realized by the second group of conductive members 75 located on the second side wall 22, so that the circuit is simplified, the wiring of the circuit is more uniform and the overall reliability is higher.

As shown in FIGS. 23, 25, and 27, it is preferable that the conductive members (fifth conductive members 75A, sixth conductive members 75B, seventh conductive members 75C, eighth conductive members 75D, ninth conductive members 75E, and tenth conductive members 75F) conductively connected to the focus coil 94, the drive integrated component 96 and the circuit board among the second group of conductive members 75 are mainly distributed in the middle and lower parts of the second side wall 22. The conductive members (fifteenth conductive members 75G, sixteenth conductive members 75H, seventeenth conductive members 75I, and eighteenth conductive members 75J) conductively connected to the swing sensing component 912 and the circuit board among the second group of conductive members 75 are mainly distributed in the upper parts of the second side wall 22. With this arrangement, the sufficient arrangement space for the conductive members between the focus coil 94, the drive integrated component 96 and the circuit board can be provided, which avoids causing mutual interference in the second group of conductive members 75, makes the circuit design more reasonable, and the circuit routing is more uniform, and the overall reliability is higher. In other words, in the second side wall 22, the circuit board fixing ends 734 of the conductive members (fifteenth conductive member 75G, sixteenth conductive member 75H, seventeenth conductive member 75I, and eighteenth conductive member 75J) conductively connected to the swing sensing component 912 and the circuit board are located on the upper side of the circuit board fixing ends 734 of the conductive members (seventh conductive member 75C, eighth conductive member 75D, ninth conductive member 75E, and tenth conductive member 75F) conductively connected to the drive integrated component 96 and the circuit board.

As shown in FIGS. 23 to 27, the first group of conductive members 74 comprises a first side portion 741, a second side portion 742, and a foundation portion 743. The foundation portion 743 is extended between the first side portion 741 and the second side portion 742, the first side portion 741 is distributed in the first side wall 21, the second side portion 742 is distributed in the third side wall 23, and the foundation portion 743 is distributed in the bottom wall 10. In manufacturing the base of the periscopic camera module, the first side portion 741, the second side portion 742 and the foundation portion 743 are initially formed by cutting one material strip, the first side portion 741, the second side portion 742 and the foundation portion 743 being positioned substantially on the same plane (the plane on which the material strip is located), and after preliminary injection molding (e.g. injection molding to form the mounting portion 40) and the bending step, the first side portion 741 finally located on the first side wall 21 and the second side portion 742 finally located on the third side wall 23 are bent vertically (substantially parallel to the first optical axis OA1). It can be understood that, in the first group of conductive members 74, in addition to the series conductive member 74E completely located on the first side wall 21, the remaining conductive members (first conductive members 74A, second conductive members 74B, third conductive members 74C, fourth conductive members 74D, eleventh conductive members 74F, twelfth conductive members 74G, thirteenth conductive members 74H and fourteenth conductive members 74I) are bent at the junction between the first side wall 21 and the bottom wall 10, and are bent at the junction between the third side wall 23 and the bottom wall 10, thereby forming the first side portion 741, the second side portion 742 and the foundation portion 743. During bending, the foundation portion 743 can be used as a base to provide positioning and support for the first side portion 741 and the second side portion 742 so as to avoid abnormal deformation during the bending step.

Further, the second group of conductive members 75 and the first group of conductive members 74 are initially formed by cutting the same material strip and are basically located on the same plane. After the preliminary injection molding step and the bending step, the second group of conductive members 75 is turned to the plane where the second side wall 22 is located. Since the second group of conductive members 75 is finally located entirely on the second side wall 22 and does not extend to the bottom wall 10, in the bending step, the second group of conductive members 75 does not need to bend at the junction between the second side wall 22 and the bottom wall 10, but indirectly turns the second group of conductive members 75 to the plane where the second side wall 22 is located by the bending the strengthening member 76, thereby facilitating ensuring the structural stability of the second group of conductive members 75 and avoiding abnormal deformation during the bending step.

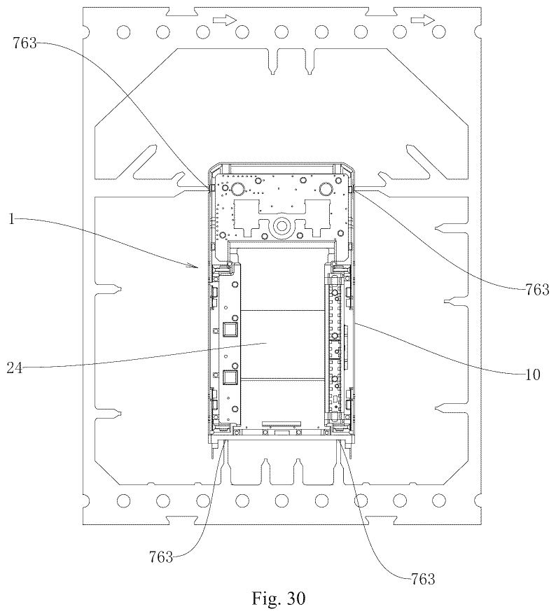

As shown in FIGS. 23, 27, 29 and 30, the base of the periscopic camera module comprises a strengthening member 76 embedded in the base. The strengthening member 76 and the conductive member 70 are initially formed by cutting the same material strip and lie substantially on the same plane. In the material strip, the strengthening member 76 and the corresponding connection auxiliary material can function to integrally connect the first group of conductive members 74, the second group of conductive members 75 and the material strip. In the final finished base, the strengthening member 76 is disposed at intervals from the first group of conductive members 74 and second group of conductive members 75. The strengthening member 76 is embedded on the bottom wall 10 and the side wall 20, and comprises a first strengthening member 761 and a second strengthening member 762 at intervals, to avoid the first group of conductive members 74, allow the first group of conductive members 74 to bend at the junction between the first side wall 21 and the bottom wall 10, and allow the first group of conductive members 74 to bend at the junction between the third side wall 23 and the bottom wall 10. The first strengthening member 761 is located at the corner formed by the first side wall 21, the third side wall 23, and the bottom wall 10, and is distributed on the first side wall 21, the third side wall 23, and the bottom wall 10, and can not only play a positioning support role when bending to help bending, but also serve as a frame of the corner, so as to facilitate subsequent formation of the base by further injection molding. The second strengthening member 762 comprises a first strengthening portion 7621, a second strengthening portion 7622, and a third strengthening portion 7623. The first strengthening portion 7621 is located at a corner formed by the first side wall 21, the second side wall 22, and the bottom wall 10, and distributed on the first side wall 21, the second side wall 22, and the bottom wall 10. The second strengthening portion 7622 is located at a corner formed by the second side wall 22 and the bottom wall 10 and close to the circuit board, and distributed on the second side wall 22, and the bottom wall 10. The third strengthening portion 7623 is located at a corner formed by the third side wall 23 and the bottom wall 10 and close to the circuit board, and distributed on the third side wall 23, and the bottom wall 10. In other words, the first strengthening portion 7621, the second strengthening portion 7622, and the third strengthening portion 7623 are located at the other three corners of the base respectively, and likewise serve as frames of the corners, so as to facilitate subsequent formation of the base by further injection molding. Since the second strengthening member 762 does not need to provide bending avoidance for the second group of conductive members 75, the second strengthening member 762 further comprises a first connecting band 7624 extending between the first strengthening portion 7621 and the second strengthening portion 7622 and located on the second side wall 22 and/or the bottom wall 10, and a second connecting band 7625 extending between the second strengthening portion 7622 and the third strengthening portion 7623 and located on the bottom wall 10, thereby enhancing the structural stability of the second strengthening member 762 by the first connecting band 7624 and the second connecting band 7625 and facilitating the subsequent formation of the base by further injection molding. It will be understood that, in the bottom wall 10, the strengthening member 76 is located outside the conductive member 70 and extended to the corner of the base.

Specifically, a part of the first group of conductive members 74 located at the junction between the first side wall 21 and the bottom wall 10, and is located between the first strengthening member 761 and the first strengthening portion 7621 of the second strengthening member 762. A part of the first group of conductive members 74 located at the junction between the third side wall 23 and the bottom wall 10 is located between the first strengthening member 761 and the third strengthening portion 7623 of the second strengthening member 762.

It can be understood that, in the bending step, during bending the first side portion 741 of the first group of conductive members 74 in a vertical arrangement, the first strengthening member 761 and the first strengthening portion 7621 of the second strengthening member 762 are bent at the same time to play a role of assisting bending. During bending the second side portion 742 of the first group of conductive members 74 in a vertical arrangement, the first strengthening member 761 and the third strengthening portion 7623 of the second strengthening member 762 is bent at the same time to play a role of assisting bending. In a case where the second group of conductive members 75 is turned to the plane where the second side wall 22 is located, it is not necessary to bend the second group of conductive members 75, but bending the first strengthening portion 7621 and/or the second strengthening portion 7622 of the second strengthening member 762, which is beneficial to ensure the structural stability of the second group of conductive members 75.

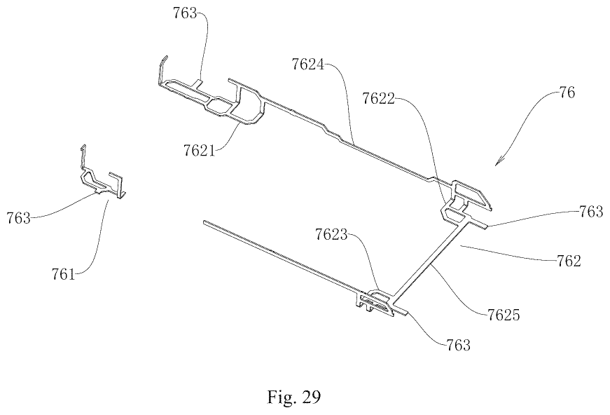

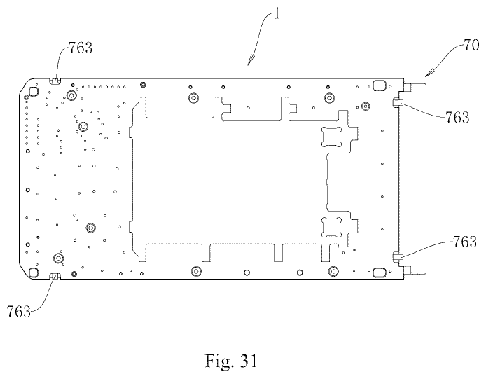

As shown in FIGS. 29 to 31, after the base is injection molded and before the peripheral auxiliary material of the material strip is removed, the base is still held in the material strip, and connected to the peripheral auxiliary material of the material strip by the strengthening member 76. The strengthening member 76 further comprises a holding end 763 exposed from the periphery of the bottom wall 10 of the base, for connecting to the peripheral auxiliary material of the material strip before removing the peripheral auxiliary material of the material strip. The holding end 763 is extended from the strengthening member 76 toward the outside of the periphery of the bottom wall 10. Optionally, the strengthening member 76 comprises at least four holding ends 763 respectively extended from the first strengthening member 761, the first strengthening portion 7621, the second strengthening portion 7622 and the third strengthening portion 7623 of the second strengthening member 762 toward the outside of the periphery of the bottom wall 10, so that the semi-finished product is better hold in the material strip.

As shown in FIG. 23, the housing 1 further comprises a fixing portion 30, and the fixing portion 30 is injection molded by a preliminary injection molding step. The fixing portion 30 covers at least part of the conductive member 70 (such as a corner part or a densely distributed part of the conductive member 70), so that the corresponding conductive member 70 can be preliminarily fixed, and the relative position between the corresponding conductive member 70 can be maintained, and the abnormal deformation of the conductive member 70 can be avoided in the subsequent bending step. The fixing portion 30 can cover at least a part of the conductive member 70 and at least a part of the strengthening member 76, so that the conductive member 70 and the strengthening member 76 can be arranged at an interval, and the relative position of the conductive member 70 and the strengthening member 76 is maintained, which is beneficial to avoid relative movement between the conductive member 70 and the strengthening member 76 in the subsequent bending step, reduces the risk of mutual contact between the conductive member 70 and the strengthening member 76, and thus is beneficial to improve the reliability of the circuit of the periscope camera module.

As shown in FIGS. 23, 26, 32 to 36, the base further comprises a reinforcing member 80 embedded in the bottom wall 10 to enhance structural reliability of the base, and the reinforcing member 80 and the conductive member 70 are positioned at intervals. The reinforcing member 80 comprises a first magnetic sheet 831 to interact with the first magnet 104 mounted on the optical path turning portion 2, which is beneficial to improve the positioning of the optical path turning portion 2 and further improve the imaging performance of the periscopic camera module. The first magnetic sheet 831 is facing the first magnet 104 on the bottom surface of the optical path turning portion 2 along the first optical axis OA1, to interact with the first magnet 104, to attract the optical path turning portion 2 and the housing 1, thereby clamping a supporting member 401 between the optical path turning portion 2 and the housing 1 to avoid detachment of the supporting member 401, and the optical path turning portion 2 is driven to be reset by interacting with the first magnetic sheet 831 and the first magnet 104. The reinforcing member 80 comprises a second magnetic sheet 841 to interact with a second magnet 303 mounted at the bottom of the lens portion 3, which is beneficial to improve the positioning of the lens portion 3 and further improve the imaging performance of the periscopic camera module. The second magnetic sheet 841 is facing to the second magnet 303 at the bottom of the lens portion 3 along the first optical axis OA1, and further generates a magnetic attraction action with the second magnet 303 on the lens portion 3, which is beneficial for driving the lens portion 3 to reset. The reinforcing member 80 is further provided with a reinforcing hole 800, and a part of the bottom wall 10 can be embedded in the reinforcing hole 800 to further increase the bonding strength between the bottom wall 10 and the reinforcing member 80, thereby further enhancing the structural reliability of the base. Optionally, the reinforcing hole 800 is a through hole penetrating the reinforcing member 80 along the first optical axis OA1. The first magnetic sheet 831 and the second magnetic sheet 841 of the reinforcing member 80 should have magnetic permeability properties. Optionally, the entire reinforcing member 80 is made of a material having magnetic permeability, such as stainless steel having magnetic permeability, and the first magnetic sheet 831 and the second magnetic sheet 841 are formed by integrally extending the reinforcing member 80.

Further, the reinforcing member 80 and the strengthening member 76 avoid each other so as to prevent the reinforcing member 80 and the strengthening member 76 from interfering with each other. The strengthening member 76 is located outside the reinforcing member 80, and the projections of the strengthening member 76 and the reinforcing member 80 are overlapped along the first optical axis OA1.

It can be understood that, since the second group of conductive members 75 no longer need to extend and be embedded in the bottom wall 10 to span the opposite side wall 20, that is, the second group of conductive members 75 no longer need to extend from the second side wall 22 to the bottom wall 10 and the third side wall 23, the part of the conductive members 70 embedded in the bottom wall 10 is reduced, and it is beneficial to embed the integral reinforcing member 80 having a larger area in the bottom wall 10, thereby integrally strengthening the structural strength of the bottom wall 10, thereby improving the reliability of the base and the periscopic camera module.

As shown in FIGS. 21 to 23, 26, 27, and 32 to 34, the supporting member 401 between the optical path turning portion 2 and the housing 1 is embodied as a ball. Accordingly, the bottom wall 10 of the housing 1 is provided with a first limiting slot 4011 and a second limiting slot 4012 to respectively limit two balls. The first limiting slot 4011 is close to the third side wall 23 and the second limiting slot 4012 is close to the second side wall 22. It will be understood that the wall thickness of the area in which the first limiting slot 4011 and the second limiting slot 4012 are opened is relatively thinner in the bottom wall 10. In order to avoid interference with the conductive member 70 and the strengthening member 76, it is necessary to avoid, that is, along the first optical axis OA1, the projections of the conductive member 70 and the strengthening member 76 are not overlapped with the projections of the first limiting slot 4011 and the second limiting slot 4012. Specifically, the foundation portion 743 of the first group of conductive members 74 forms a first avoidance space 7431 directly facing the first limiting slot 4011, and a second avoidance space 7432 directly facing the second limiting slot 4012 is formed between the foundation portion 743 of the first group of conductive members 74 and the strengthening member 76. Optionally, the first avoidance space 7431 is formed between the thirteenth conductive member 74H and the fourteenth conductive member 74I. Optionally, the second avoidance space 7432 is formed between the fourth conductive member 74D and the first strengthening portion 7621 of the second strengthening member 762.

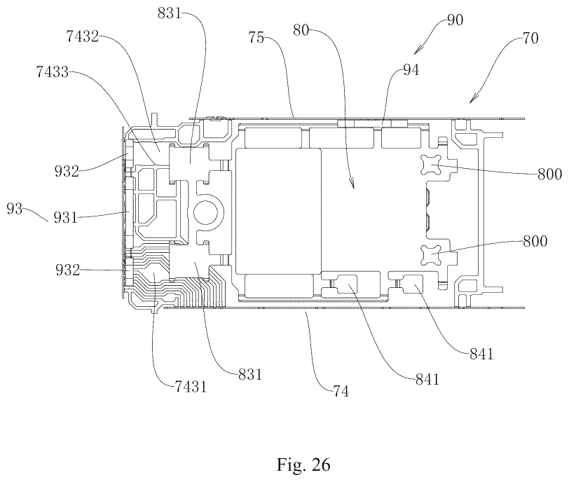

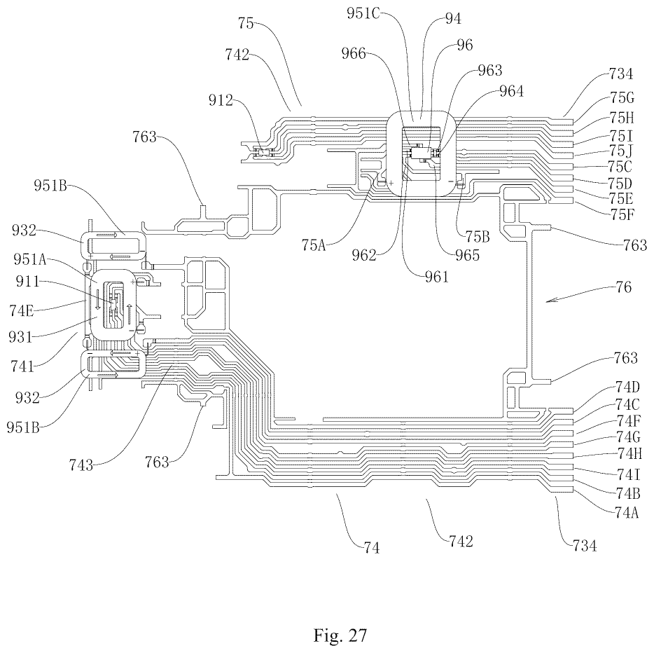

As shown in FIGS. 26 and 27, since the electronic component fixing end 733 of the fourth conductive member 74D is connected to the swing coil 932 close to the second side wall 22, the fourth conductive member 74D is distributed in a relatively sparse area in the foundation portion 743. In order to make the arrangement of the foundation portion 743 more uniform, the foundation portion 743 comprises an extension portion 7433 to enhance structural stability, avoid damage and breakage in the bending step and the injection molding step, and to enhance the structural strength of the bottom wall 10 and enhance the overall reliability. Specifically, the extension portion 7433 is provided on the fourth conductive member 74D. In other words, the extension portion 7433 is provided on the conductive member conductively connected the circuit board and the swing coil 932 close to the second side wall 22. Optionally, the extension portion 7433 has a mesh structure.

As above, the disclosure further provides a manufacturing method for the base of the periscopic camera module, comprising the following steps:
a, providing a material strip for forming a conductive member 70 and a strengthening member 762, the conductive member 70 comprising a first group of conductive members 74 and a second group of conductive members 75, the material strip being cut according to a planar layout pattern of the first group of conductive members 74, the second group of conductive members 75 and the strengthening member 76 in the material strip, to obtain a first semi-finished product;
b, firstly injection molding the first semi-finished product, to form the mounting portion 40, to obtain a second semi-finished product;
c, providing an electronic assembly 90, to mount the electronic assembly 90 on the mounting portion 40 of the second semi-finished product, and weld the electronic assembly 90 with the electronic component fixing end 733 of the conductive member 70, to obtain a third semi-finished product;
d, bending the first group of conductive members 74 and the strengthening member 76 of the third semi-finished product, to form a foundation portion 743 located on the bottom wall 10, a first side portion 741 located on the first side wall 21, and a second side portion 742 located on the third side wall 23, to obtain a fourth semi-finished product;
e, providing a reinforcing member 80 on the fourth semi-finished product and secondly injection molding, to form the bottom wall 10, the first side wall 21, the second side wall 22 and the third side wall 23 of the base, to obtain a fifth semi-finished product, the fifth semi-finished product held in material strip by the holding end 763 connected to the peripheral auxiliary material of material strip; and
f, cutting to separate the holding end 763 from the peripheral auxiliary material of the material strip, to obtain the base.

Optionally, in Step b, the first semi-finished product is injection molded for the first time, and the mounting portion 40 and the fixing portion 30 are formed at the same time.

Further, after Step a, but before Step d, the method further comprises the steps of:
cutting and removing a connection auxiliary material of the material strip, where the connection auxiliary material is located between the adjacent conductive members 70, between the conductive members 70 and the material strip, between the conductive members 70 and the strengthening member 76, and/or between the strengthening member 76 and the material strip.

In addition, the disclosure further provides a periscopic camera module, comprising:
the base, defining an accommodation space 24;
an optical path turning portion 2, mounted in the accommodation space 24, the optical path turning portion 2 and the anti-shake coil 93 facing each other along the second optical axis OA2, and the optical path turning portion 2 being driven to perform anti-shake motion;
a lens portion 3, mounted in the accommodation space 24, the lens portion 3 and the focus coil 94 facing each other along the third axis A3, and the lens portion 3 being driven to perform focus motion; and
a photosensitive assembly, where the circuit board fixing end 734 of the conductive member 70 is conductively connected to the circuit board of the photosensitive assembly.

It will be understood by those skilled in the art that the above embodiments are merely examples, features of different embodiments can be combined with each other to obtain embodiments that are readily conceivable in accordance with the disclosure of the disclosure but which are not explicitly shown in the drawings.

It will be understood by those skilled in the art that the above description and the embodiments shown in the accompanying drawings are merely for illustrative explanation of the disclosure, and are not intended to limit the disclosure. All equivalent embodiments, modifications and improvements within the spirit of the disclosure are intended to be comprised within the scope of protection of the disclosure.

1: A base of a periscopic camera module, comprising:
a housing, comprising a bottom wall and a side wall located on a peripheral side of the bottom wall;
a plurality of conductive members, each of the plurality of conductive members comprising a connecting branch embedded in the bottom wall and a mounting branch embedded in the side wall, the connecting branch and the mounting branch being connected, wherein the mounting branch comprises a first portion, a second portion, and a third portion distributed separately from each other on the side wall, and the first portion, the second portion, and the third portion are respectively embedded in three different side walls;
an anti-shake coil, conductively connected to the first portion, wherein the anti-shake coil is parallel to a first optical axis of the periscopic camera module and perpendicular to a second optical axis of the periscopic camera module;
a focus coil, conductively connected to one of the second portion and the third portion, to be disposed on different sides relative to the anti-shake coil; and
a controlling portion, conductively connected to one of the second portion and the third portion, to be disposed on different sides relative to the anti-shake coil and the focus coil, wherein the anti-shake coil and the focus coil are respectively conductively connected to the controlling portion via the connecting branch, to be controlled by the controlling portion.

2: The base of the periscopic camera module according to claim 1, wherein the first portion, the second portion, and the third portion are respectively distributed on three peripheral sides of the connecting branch at intervals from each other, so as to be bent relative to the connecting branch without interfering with each other, to form an arrangement perpendicular to the connecting branch.

3: The base of the periscopic camera module according to claim 1, wherein the side wall comprises a first side wall, a second side wall, and a third side wall located on three peripheral sides of the bottom wall, the first side wall being parallel to the first optical axis of the periscopic camera module and perpendicular to the second optical axis of the periscopic camera module, the second side wall and the third side wall being facing to each other, wherein the first portion, the second portion, and the third portion are respectively embedded in the first side wall, the second side wall, and the third side wall.

4: The base of the periscopic camera module according to claim 1, wherein each of the plurality of conductive members comprises at least two fixing ends located on the side wall and conductively connected to the mounting branch, and the fixing ends and the mounting branch are disposed on different surfaces, so that the mounting branch is embedded in the side wall and the fixing ends are exposed on the side wall.

5: The base of the periscopic camera module according to claim 4, wherein the fixing end comprises a connecting end comprising a first connecting end connected to the first portion and a second connecting end connected to at least one of the second portion and the third portion, the first connecting end is fixed to the anti-shake coil, and the second connecting end is fixed to the focus coil.

6: The base of the periscopic camera module according to claim 5, wherein the connecting end comprises a third connecting end connected to the second portion and the third portion, and the third connecting end is exposed on an end of the side wall away from the side where the first portion is provided and is adapted to be fixed to a photosensitive assembly of the periscopic camera module.

7: The base of the periscopic camera module according to claim 1, further comprising: a plurality of reinforcing members, embedded in the bottom wall, wherein the plurality of reinforcing members and the plurality of conductive members are positioned at intervals, each of the reinforcing members comprises a first reinforcing portion and a second reinforcing portion connected to each other, the first reinforcing portion and the second reinforcing portion are disposed on different surfaces, and the first reinforcing portion is adapted to support the second reinforcing portion, so that the second reinforcing portion and the connecting branch have partially overlapped projections along the first optical axis of the periscopic camera module.

8: The base of the periscopic camera module according to claim 7, wherein the first reinforcing portion and the connecting branch are located in one same plane, and the first reinforcing portion and the connecting branch are positioned at intervals.

9: The base of the periscopic camera module according to claim 7, wherein the plurality of reinforcing members comprises a first reinforcing member and a second reinforcing member, the first reinforcing member and the optical path turning portion of the periscopic camera module are facing each other along the first optical axis, and at least part of the first reinforcing member forms a first magnetic sheet, to interact with an anti-shake magnet mounted on the optical path turning portion, the second reinforcing member and the lens portion of the periscopic camera module are facing each other along the first optical axis, and at least part of the second reinforcing member forms a second magnetic sheet, so as to interact with focus magnet mounted on the lens portion.

10: The base of the periscopic camera module according to claim 7, wherein the housing comprises a fixing portion covering at least part of the plurality of conductive members and at least part of the plurality of reinforcing members, so that the plurality of conductive members and the plurality of reinforcing members are positioned at intervals.

11-14: (canceled)

15: A base of a periscopic camera module, comprising:
a housing, comprising a bottom wall and a plurality of side walls located on a peripheral side of the bottom wall;
a plurality of conductive members, embedded in the bottom wall and the plurality of side walls; and
a strengthening member, embedded in the base, spaced apart from the plurality of conductive members, and distributed on the plurality of side walls and the bottom wall, wherein in the bottom wall, the strengthening member is located outside the plurality of conductive members and extended to a corner of the base, wherein the reinforcing member and the plurality of conductive members are cut from one same material strip.

16: The base of the periscopic camera module according to claim 15, wherein the plurality of side walls comprises a first side wall, a second side wall, and a third side wall, wherein the first side wall is parallel to a first optical axis of the periscopic camera module and perpendicular to a second optical axis of the periscopic camera module, and the second side wall and the third side wall are facing each other along a third axis.

17: The base of the periscopic camera module according to claim 16, wherein the strengthening member comprises a first strengthening member and a second strengthening member, wherein the first strengthening member and the second strengthening member are spaced apart from each other, the first strengthening member is located at a corner formed by the first side wall, the third side wall and the bottom wall, and the second strengthening member comprises a first strengthening portion, a second strengthening portion, and a third strengthening portion, wherein the first strengthening portion, the second strengthening portion, and the third strengthening portion are respectively located at three other corners of the base.

18: The base of the periscopic camera module according to claim 17, wherein the strengthening member comprises at least four holding ends, wherein the first strengthening member, the first strengthening portion, the second strengthening portion, and the third strengthening portion are extended and exposed to an outside of a peripheral edge of the bottom wall, to form the at least four holding ends.

19: The base of the periscopic camera module according to claim 17, wherein the conductive members comprise a first group of conductive members and a second group of conductive members, wherein the first group of conductive members is embedded in the first side wall, the bottom wall and the third side wall, the second group of conductive members is embedded in the second side wall, the first group of conductive members comprises a first side portion distributed on the first side wall, a second side portion distributed on the third side wall, and a foundation portion distributed on the bottom wall, the first group of conductive members comprises a circuit board fixing end conductively connected to a circuit board of a photosensitive component, and the second group of conductive members comprises a circuit board fixing end conductively connected to the circuit board.

20: The base of the periscopic camera module according to claim 19, wherein the first group of conductive members is located at a part of a junction between the first side wall and the bottom wall, between the first strengthening member and the first strengthening portion of the second strengthening member, and the first group of conductive members is located at a part of a junction between the third side wall and the bottom wall, between the first strengthening member and the third strengthening portion of the second strengthening member.

21: The base of the periscopic camera module according to claim 20, further comprising: an anti-shake coil disposed on the first side wall and a focus coil disposed on the second side wall, wherein the first group of conductive members comprises an electronic component fixing end conductively connected to the anti-shake coil, the first group of conductive members is adapted to conductively connect the anti-shake coil and the circuit board, and the second group of conductive members comprises an electronic component fixing end conductively connected to the focus coil.

22: The base of the periscopic camera module according to claim 21, further comprising: a drive integrated component disposed on the second side wall, wherein the second group of conductive members comprises an electronic component fixing end conductively connected to the drive integrated component, the second group of conductive members conductively connects the focus coil and the drive integrated component, and the second group of conductive members is adapted to conductively connect the drive integrated component and the circuit board.

23: (canceled)

24: The base of the periscopic camera module according to claim 22, further comprising: a swing sensing component disposed on the second side wall, wherein the second group of conductive members further comprises an electronic component fixing end conductively connected to the swing sensing component, and the second group of conductive members is adapted to conductively connect the swing sensing component and the circuit board.

25-28: (canceled)

29: The base of the periscopic camera module according to claim 22, further comprising: a reinforcing member in integral, wherein the first magnetic sheet and the second magnetic sheet of the reinforcing member are integrally formed by extending the integral reinforcing member.

30-34: (canceled)
